(19) United States
(12) Patent Application Publication
(10) Pub. No.: US 2014/0195332 A1
(43) Pub. Date: Jul. 10, 2014

(54) ADVERTISING CAMPAIGN PLANNER FOR OPTIMUM LEAD DELIVERY AND QUALITY TO ADVERTISERS WITH PARETO-OPTIMAL PRICING BETWEEN ADVERTISERS AND PUBLISHERS

(71) Applicant: Pontiflex, Inc., Brooklyn, NY (US)

(72) Inventors: Geoffrey B. Grauer, Brooklyn, NY (US); Zephrin I. Lasker, Brooklyn, NY (US); Roshan B. Bangera, Brooklyn, NY (US); Sampath Kumar, Brooklyn, NY (US)

(73) Assignee: Pontiflex, Inc., Brooklyn, NY (US)

(21) Appl. No.: 14/079,328

(22) Filed: Nov. 13, 2013

Related U.S. Application Data
(63) Continuation-in-part of application No. 13/413,471, filed on Mar. 6, 2012.
(60) Provisional application No. 61/449,750, filed on Mar. 7, 2011.
(60) Provisional application No. 61/725,763, filed on Nov. 13, 2012.

(51) Int. Cl. G06Q 30/02

(52) U.S. Cl. CPC G06Q 30/0243
USPC 705/14.42

(57) ABSTRACT

Systems and methods are disclosed for planning an advertisement campaign. In one implementation, a processing device provides one or more advertisements associated with a first advertising campaign within one or more advertising placements, each of the one or more advertisements being configured to receive sign-up information from one or more users, the one or more advertising placements corresponding to one or more related advertising impressions. Sign-up information is received from one or more users via the one or more advertisements. One or more messages are sent, based on the sign-up information, to each of the one or more users. One or more responses to the one or more messages are received. Based on the one or more responses, a user engagement level of the first advertising campaign is determined. Based on the user engagement level of the first advertising campaign, a user engagement level of a second advertising campaign is forecasted.

### CROSS-REFERENCE TO RELATED APPLICATIONS

This application is a continuation-in-part of U.S. patent application Ser. No. 13/413,471, filed Mar. 6, 2012, which claims the benefit of U.S. Patent Application No. 61/449,750, filed Mar. 7, 2011, each of which are incorporated herein by reference. This application is also related to and claims the benefit of U.S. Patent Application No. 61/725,763, filed Nov. 13, 2012, the entirety of which is incorporated herein by reference.

### TECHNICAL FIELD

Aspects and implementations of the present disclosure relate to planning an advertisement campaign.

### BACKGROUND

In Internet and mobile phone advertising environments, publishers may be defined as Internet sites or mobile applications that offer spots of online real estate where an advertisement message (text, images, video etc.) may be shown. These spots (also called placements) command an economic value since one or more advertisers may be able to place their messages there and derive a monetary value from it. The value varies from advertiser to advertiser depending on the product being advertised and the interests of visitors to a publisher's site.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device provides one or more advertisements associated with a first advertising campaign within one or more advertising placements, each of the one or more advertisements being configured to receive sign-up information from one or more users, the one or more advertising placements corresponding to one or more related advertising impressions. Sign-up information is received from one or more users via the one or more advertisements. One or more messages are sent, based on the sign-up information, to each of the one or more users. One or more responses to the one or more messages are received. Based on the one or more responses, a user engagement level of the first advertising campaign is determined. Based on the user engagement level of the first advertising campaign, a user engagement level of a second advertising campaign is forecasted.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of a system architecture of a computer system that provides a data bridge for transferring data between Publishers/Developers and Advertisers.

FIGS. 2-4 show screens used to describe a data consumer configurator of the computer system shown in FIG. 1.

FIGS. 5-7 show screens used to describe a data source configurator of the computer system shown in FIG. 1.

FIGS. 8-11 show screens used to describe a data transfer configurator of the computer system shown in FIG. 1.

FIGS. 12-14 show diagrams used to describe data components that make up a Data Source Configuration, a Data Consumer Configuration and a Data Transfer Configuration, respectively, as stored in a configuration data store of the computer system shown in FIG. 1.

FIG. 15 shows an HTML source code view of a sample data source-owned HTML web page that includes a BrowserScriptPost code snippet useful for sending data to the computer system shown in FIG. 1.

FIG. 16 shows pseudo code describing a JavaScript function of a component of the BrowserScriptPost code snippet shown in FIG. 15.

There are no FIGS. 17-20.

FIG. 21 is a flow diagram showing a sequence of events from a user's perspective as the user interacts with an Ad Unit presented within a mobile device application, which Ad Unit and which method of user interaction are fabricated in accordance with one or more embodiments of the present disclosure.

FIG. 22 is a block diagram of components of an Ad Server computer system that is fabricated in accordance with one or more embodiments of the present disclosure.

FIG. 23 shows an Offer object that has been fabricated in accordance with one or more embodiments of the present disclosure and its relationship to a Data Transfer Configuration.

FIG. 24 shows an Offer Configuration web form that is fabricated in accordance with one or more embodiments of the present disclosure for use by an Advertiser in creating the Offer object shown in FIG. 23.

FIG. 25 shows a Data Source Registration Offer Screen and a RegistrationOffer object that are fabricated in accordance with one or more embodiments of the present disclosure.

FIG. 26 shows a Download Application Ad Configuration web form and an Application Ad Configuration that are fabricated in accordance with one or more embodiments of the present disclosure.

FIG. 27 shows Application Ad Library components that have been fabricated in accordance with one or more embodiments of the present disclosure.

FIG. 28 shows Application Ad Library screens that are generated in accordance with one or more embodiments of the present disclosure.

FIG. 29 depicts a flow diagram of aspects of a method for planning an advertising campaign, in accordance with one implementation of the present disclosure.

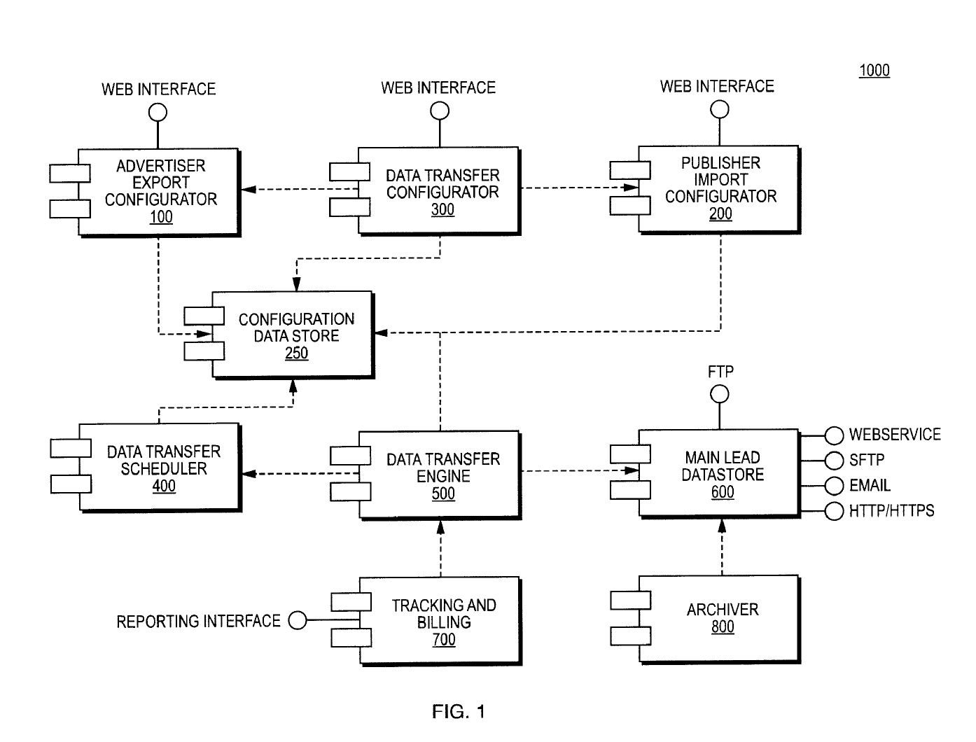

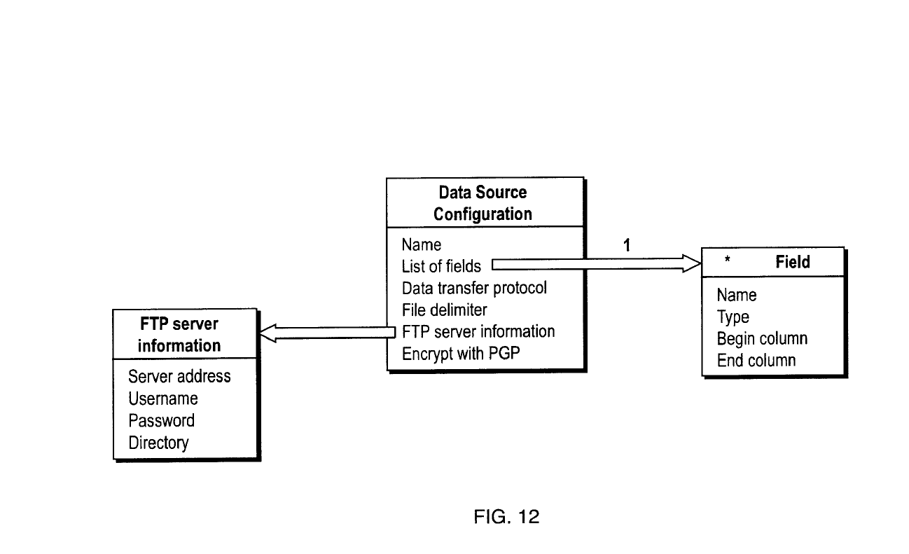

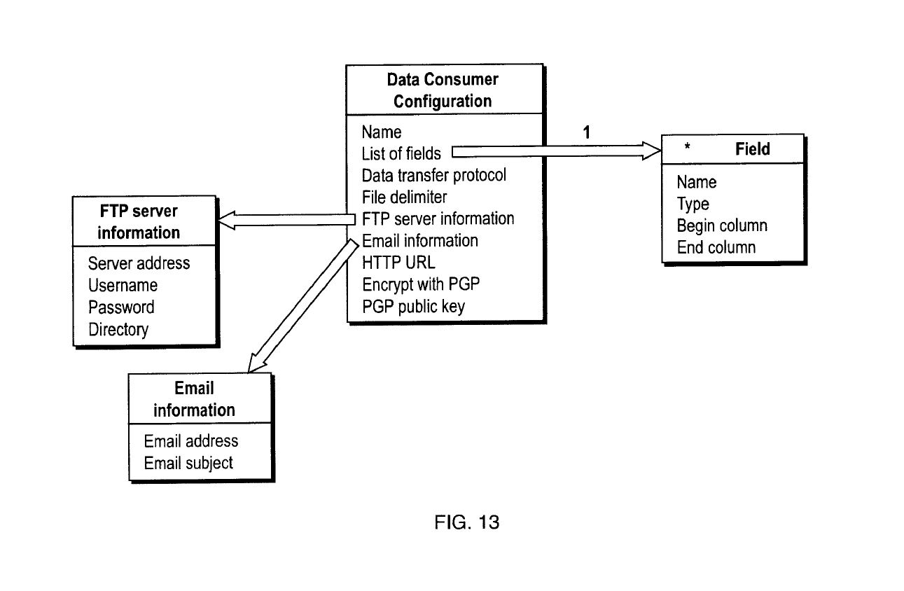

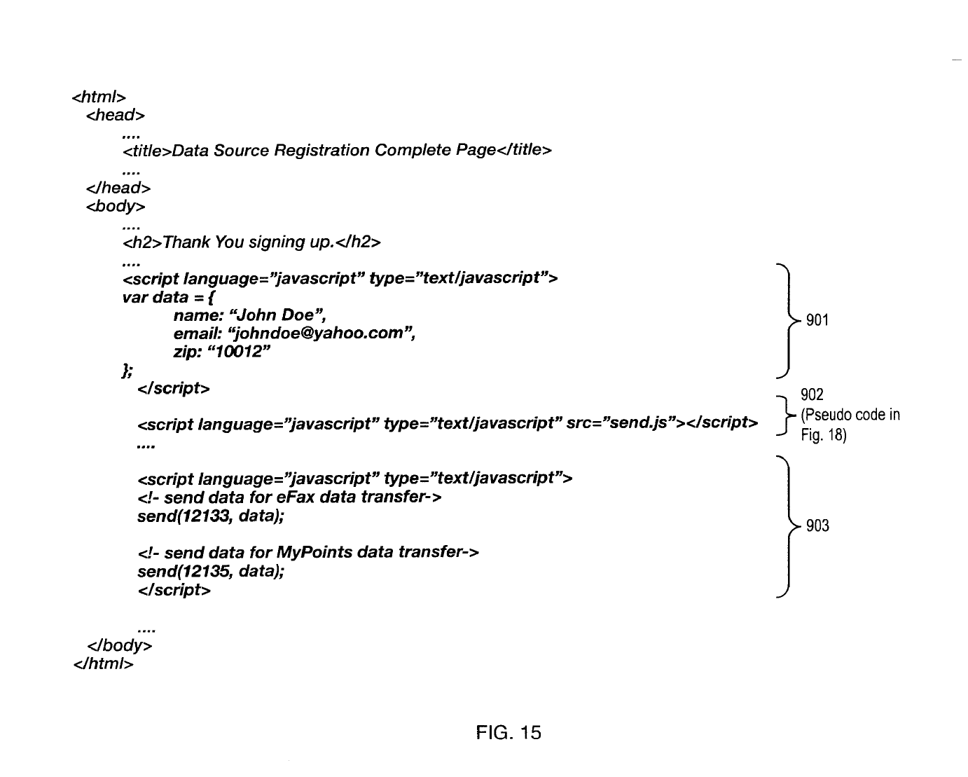

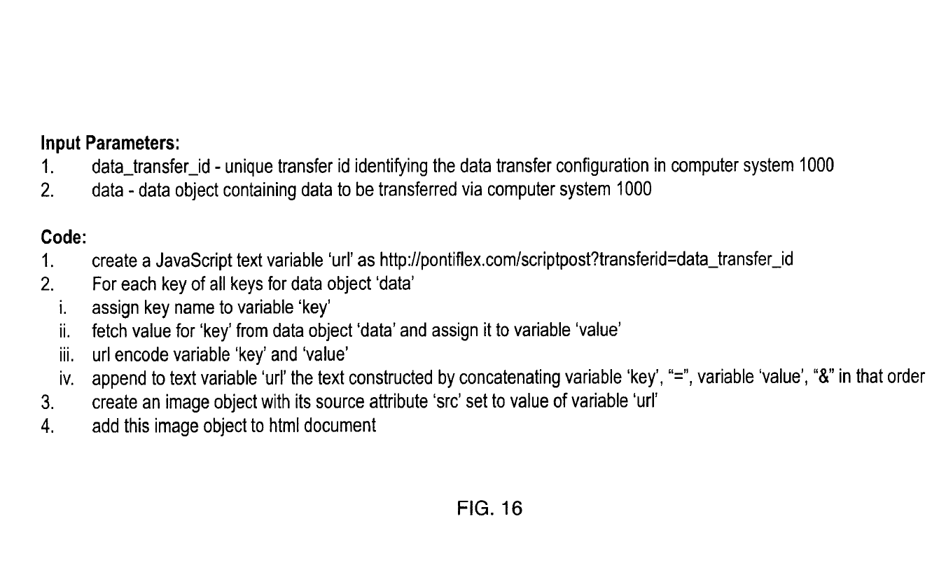

FIGS. 1-11 referenced above all come from, and have the same figure numbers assigned to them in, a U.S. patent application entitled “System and Method for Connecting and Managing Data Transfers Over the Internet,” having application Ser. No. 11/801,330, which application was filed on May 9, 2007, was published as U.S. Publication No. 2007/0294133A1 (referred to herein as the “Pontiflex Application”), and is assigned to the assignee of the present patent application, and which patent application and publication are incorporated by reference herein. FIGS. 12-14, 15 and 16 referenced above all come from the Pontiflex Application. In particular, FIGS. 12-14 of this application correspond to FIGS. 13-15 of the Pontiflex Application; FIG. 15 of this application corresponds to FIG. 17 of the Pontiflex Application; and FIG. 16 of this application corresponds to FIG. 18 of the Pontiflex Application.

### DESCRIPTION OF EMBODIMENTS

Various factors are taken into consideration when planning an advertisement campaign. At least two factors include identifying which publishers are best suited to run the campaign and the cost willing to be paid for placements that are most likely to yield the best return on advertisement dollars invested. Typically, making these determinations is beyond the capability of most advertisers (apart from the technical aspects of serving ads in real time to net visitors). Accordingly, most advertisers are inclined to rely on services of known advertisement platforms such as Google, Yahoo and the like to run their online advertisement campaigns.

An online advertisement platform (such as is described herein) acts as a broker between advertisers and publishers (in addition to physically serving the chosen advertisements at the chosen placements in real time) and, with perfect information, would produce a Pareto-optimal outcome for all participants. For a system in Pareto-optimal equilibrium, any change to make some members better off would lead to others being worse off. Pareto-optimality can be advantageous for stable operation of the system since advertisers and publishers typically have conflicting goals, especially in performance marketing campaigns. Publishers would like to get the best prices for their inventory, whereas advertisers would like to pay no more for an advertisement placement than the monetary value derived from it. Pareto-optimality consists of each advertiser bidding his best price at each publisher and each publisher selecting from available bids to maximize their gain.

Accordingly, described herein are various technologies that provide an improved platform that can manage a plurality of advertisers and publishers, wherein the platform is configured to take into consideration various criteria for planning an optimal advertisement campaign that serves the needs of all participating entities and provides the best return on advertisement investment dollars.

The present disclosure provides for a platform enabled to manage an advertisement planning environment between advertisers, taking into consideration their needs and requirements, and publishers able to serve those needs and requirements. The platform creates synergies with a plurality of advertisers and publishers that are not available to advertisers and publishers individually. More specifically, the present disclosure can achieve a globally Pareto-optimal outcome by: (i) forecasting the value of each placement to an advertiser based on historical data for similar campaigns and publishers; (ii) selecting the publishers for each campaign and the prices to be paid to the selected publishers using one or more algorithm(s) that produce an optimal outcome for the campaign, while also ensuring that the publisher continues to get the equilibrium monetary value from his placements; (iii) incorporating the concept of scarcity-pricing, charging more than the Pareto-optimal price if the advertiser asks for leads arising from impressions that are scarce in the system; and (iv) in analogy with auctions with reserve prices, ensuring a minimum expected revenue per impression to each publisher.

In the present disclosure, a system and method for identifying a campaign plan that optimally balances the needs of advertisers and publishers is provided. The present disclosure is illustrated by way of example, and not by way of limitation, and will become apparent upon consideration of the description, taken in conjunction with the accompanying drawings.

A campaign plan consists of selecting publishers to run an advertisement campaign and determining the price to be paid to each of the selected publishers. Depending on the goals of the campaign, the billing model used for paying the publisher may be any one of the following: (i) cost per thousand impressions served (CPM); (ii) cost per click (CPC); (iii) cost per lead or sign-up (CPL or CPS); (iv) cost per action (CPA) where the action taken by the viewer of the advertisement may vary by campaign (e.g., purchase of a product, installing an application, etc.).

In the present disclosure, a campaign planner platform configured to optimize and automate a campaign planning process for CPL campaigns may be provided. Although the methodology described herein refers to planning CPL campaigns, the methodology is analogous for cases where the conversion event the advertiser is willing to pay for is one of the other events, such as clicks or purchases. Using the platform, an entire campaign may be planned utilizing a set of campaign metadata and KPI requirements that may be provided, for example, by an advertiser utilizing a user-interface communicatively coupled to the platform. In one embodiment, inputs received by the platform to initiate the campaign planning process may include, but are not limited to a campaign budget, a target country an advertiser would like to receive visitor-impressions from, a set of categorical descriptions of the related business (e.g., apparel>clothing and accessories>gems and jewelry), a set of desired lead fields (e.g., a default setting of fields may provide for collection of name, e-mail and postal code information for each sign-up) or various combinations thereof.

Processing the inputs received for a campaign, the platform may be configured to output the expected time frame associated with completion of the campaign, estimate number of sign-ups that can be expected, estimated average cost per sign-up, a maximum guaranteed cost per sign-up or any other measure useful for refining a campaign plan to meet an advertiser's objectives. The advertiser may refine a proposed campaign plan by supplying an additional number of elements including, but not limited to, targeting requirements by state, metro codes and postal codes, sign-up fields such as telephone, date or birth, a daily leap cap, a daily budget cap, a monthly budget cap, a maximum amount willing to be paid for a lead (overriding the guaranteed maximum) or various combinations thereof. The platform may process these additional input refinements and output a revised or new campaign plan.

As described herein, additional KPI requirements that may be provided and retrieved by the platform for generating a campaign plan include, but are not limited to: (i) the most that the expected CPL of a campaign can be (“Max Blended CPL”); (ii) the least that the expected CPL of the campaign can be (“Min Blended CPL”); (iii) the most that can be charged for sign-ups from scarce impressions (“Max Punitive CPL”), such as those targeted to a narrow geographic area; (iv) start and end dates (“Campaign Start Date” and “Campaign End Date”); (v) the lowest average quality score an SLI (source line item, e.g., grouping of placements based on similarity of attributes such as vertical, publisher quality etc. to achieve a relatively homogeneous and stable incoming impression volume, whereby large placements can stand as their own source line item) can have to be included in the campaign plan (“Min Avg Quality Score”); (vi) the highest average quality score an SLI can have to be included in the campaign plan (“Max Avg Quality Score”); and (vii) a lower bound for the overall blended average quality score of signups resulting from the campaign (“Min Blended AQS”).

Any combination or variation of values associated with the additional KPI requirements may be considered by the platform to interactively respond with adjusted campaign plan proposals. In one embodiment, the additional KPI requirements may be preset default values with limited accessibility to users interacting with the platform. For example, accessibility by external users to the additional KPI requirements may be limited, with full accessibility given to administrative-level users tasked with confirming that an acceptable final version of a campaign plan is generated.

What is known about commercially available paid-search platforms is that they achieve Pareto-optimality among bidders for individual keywords. Each bidder on a keyword bids what it is truly worth to them, the keyword being allocated to the bidder who values it the most. In this model, the primary focus seems to be to maximize what each keyword can earn from bidders interested in it, while not accounting for campaign budgets in determining allocation of the keyword, except to shut down a campaign once its daily budget cap or total remaining budget is reached.

Alternatively, using the platform of the present disclosure, the KPI requirements, lead price and quality available from eligible publishers, and a Pareto-optimal price-volume relationship between the payout offered to each publisher and the resulting impression volume received by the campaign may all be taken into consideration. By looking at the totality of eligible publishers with respect to the total campaign budget and optimizing for quality, delivery and price at the same time without impacting publisher-economics allows for a suitable campaign plan to be proposed that is advantageous to both advertisers and publishers.

As also described herein, eCPM (Effective Cost Per 1000 (Mille) impressions) curves may be used to determine the impact of a proposed campaign plan on publishers. Using eCPM curves by SLI is to ensure that new campaigns leave publishers revenue-neutral. eCPM curves may be estimated, for example, based on two weeks of the most recent pay out data for each SLI and updated daily. These curves may divide up the total impressions arriving at an SLI into five quintiles, each quintile consisting of approximately one-fifth of the available impressions. The price per impression of each quintile is the average payout received from existing campaigns in that quintile. The quintile eCPMs would determine the minimum payout required to be paid by the new campaign to receive the optimum proportion of impressions in that quintile, after considering existing campaigns in that quintile, and not leave the publisher worse off. The eCPM curves may also be designed to achieve a minimum guaranteed eCPM to each SLI.

In another embodiment, the campaign planning platform may be configured to perform metric forecasts for new campaigns to predict how a potential new campaign would perform at a publisher without serving a single impression for the new campaign (as described herein). In performing the metric forecasts for new campaigns, the take rate by publisher, the average quality score by publisher, and dup and invalid rates by publisher may all be estimated based on descriptive tags provided by an advertiser regarding the product or service being offered and the type of incentive in the offer. All existing campaigns with known performance metrics would also have these tags. The platform may then employ a tag to performance-metric mapping process, which may be used to map known metrics from existing campaigns to the unknown metrics of the new campaign based on tag-similarity.

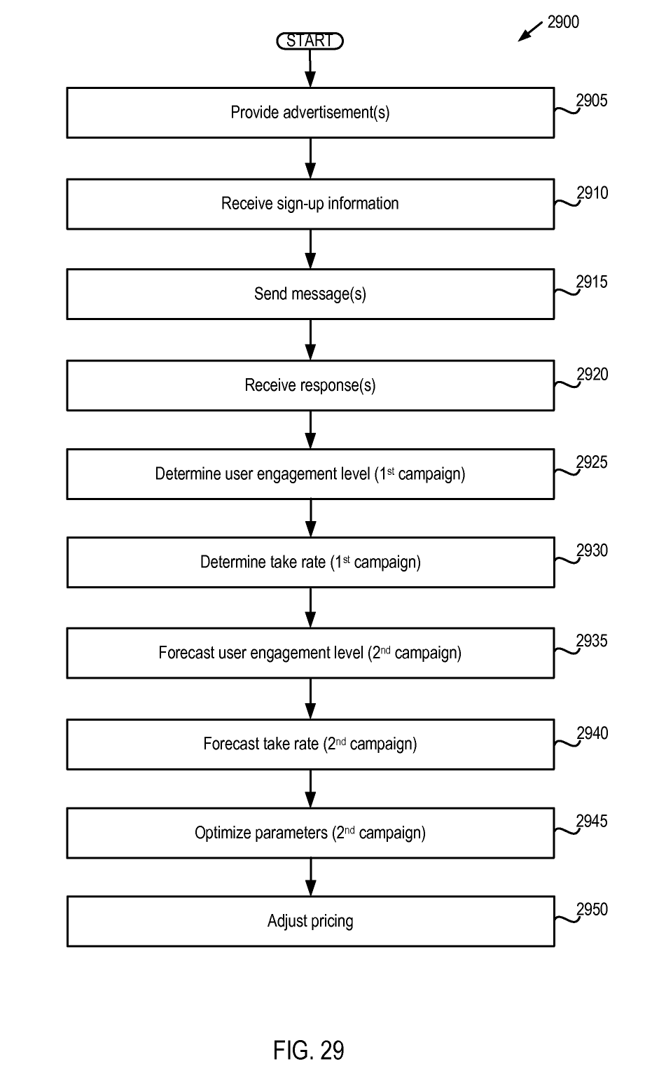

FIG. 29 depicts a flow diagram of aspects of a method 2900 for planning an advertisement campaign. For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 2905, one or more advertisements associated with a first advertising campaign are provided within one or more advertising placements. In certain implementations, each of the one or more advertisements can be configured to receive sign-up information from one or more users. Moreover, in certain implementations the one or more advertising placements can correspond to one or more related advertising impressions. Additionally, in certain implementations each of the one or more advertisements is associated with an advertiser.

At block 2910, sign-up information is received, such as from one or more users via the one or more advertisements. At block 2915, one or more messages are sent to one or more users, such as based on the sign-up information. At block 2920, one or more responses to the one or more messages can be received. In certain implementations, the referenced responses can include an opening of the message and/or an interaction with the message. Based on the one or more responses, at block 2925 a user engagement level of the first advertising campaign can be determined. In certain implementations, determining a user engagement level can include determining, based on prior user activity and/or information pertaining to user interests, a user engagement level of the first advertising campaign. Moreover, in certain implementations determining a user engagement level can include adjusting a user engagement level of the first advertising campaign based on one or more instances of filtering of the one or more messages (e.g., by a spam filter).

At block 2930, a take rate of the first advertising campaign can be determined. Based on the user engagement level of the first advertising campaign, at block 2935 a user engagement level of a second advertising campaign is forecasted. At block 2940, a take rate of the second advertising campaign can be forecasted, such as based on the take rate of the first advertising campaign. In certain implementations, forecasting a take rate of the second advertising campaign can include adjusting the take rate of the second advertising campaign based a brand quality score of the second advertising campaign and/or an offer incentive score of the second advertising campaign.

At block 2945, one or more parameters of the second advertising campaign can be optimized, such as based on the user engagement level of the second advertising campaign and the take rate of the second advertising campaign. At block 2950, a pricing associated with the second advertising campaign can be adjusted, such as based on one or more parameters associated with the second advertising campaign and a minimum spending requirement.

The Internet has become an important medium for advertising. In general, buyers and sellers of Internet advertising can be divided into two of the following categories: (a) Publishers (a Publisher is also referred to herein as a “data source”)—for example and without limitation, a Publisher is a website or a network of websites or a mobile phone network or a television network or a computer system or a mobile device application supplier (which mobile app is designed to run on a mobile device and which mobile app, in accordance with one or more embodiments of the present disclosure, can display Ad Units in the mobile app), or a mobile device running a mobile app and so forth that displays advertising units (“Ad Units”) on behalf of Advertisers (examples of Publishers are Aptimus, Valueclick, Verizon Wireless, Comcast Cable, New York Times Online, and Lycos); and (b) Advertisers (an Advertiser is also referred to herein as a “data consumer”)—for example and without limitation, an Advertiser is a company (selling one or more products and/or services) that contracts with a Publisher to display the Advertiser's ads or advertising units on the Publisher's sites (examples of Advertisers are HPShopping, Verisign, Circuit City and eFax). Although the above describes traditional Publishers, embodiments of the present disclosure also relate to Publishers of Ad Units on mobile devices and, in particular, to Publishers of Ad Units that are displayed, and from which data is captured and transmitted to, among others, Advertisers, within mobile applications (“apps”) that run on mobile devices. In addition, such the term Publisher may also include a Developer of a mobile app, which mobile app, in accordance with one or more embodiments of the present disclosure, can display Ad Units in the mobile app on a mobile device. In addition, the term Advertiser, when used in the context of receiving information from a Publisher, also refers to a computer system comprised of one or more computers that can receive information over the Internet. In particular, and as is described in more detailed herein, such Advertiser computer systems can receive information from a data bridge system over the Internet, which information was transmitted by Publishers to the data bridge computer system over the Internet in the manner described herein.

As is well known, common types of online advertising units (Ad Units) are, for example and without limitation, banners, buttons, opt-ins, email and paid search. In general, Publishers display Ad Units for Advertisers. In addition, and in general, prior art online Ad Units can be divided into two of the following categories, which categories are based on a method by which Advertisers collect data from a consumer of an Advertiser's product(s) or service(s): (a) re-directed Ad Units wherein a consumer clicks (using, for example, and without limitation, a user interaction device such as a computer mouse or a mobile device touch screen) on an Ad Unit, search result, or other Ad Unit displayed, for example, and without limitation, in a web browser on a user interface (for example, and without limitation, a computer display such as a screen of a mobile device or a monitor on a laptop computer of a notebook computer and the like) and is re-directed (for example and without limitation, either in a new browser window or by refreshing a current browser window) to an Advertiser's web form—the consumer then manually completes the web form by entering required data; and (b) Publisher-collected Ad Units wherein the consumer takes some action (for example and without limitation, checking or leaving checked, a pre-selected check-box—often during a website registration process) that causes the Publisher to transfer the consumer's data in the background to the Advertiser. However, in accordance with the present disclosure, Ad Units are presented to a user of a mobile device (for example, and without limitation, on the mobile device display screen) within his/her mobile application (“app”), and the user interacts with the Ad Unit (using, for example and without limitation, a mobile device touch screen and/or input device) without leaving the mobile app. For this reason, the term consumer will be taken to include the term user, and the term user includes the term consumer.

In accordance with one or more embodiments of the present disclosure, a programmable interface comprised of a library of software modules (referred to herein as an “Application Ad Library”) is made available to a mobile device app, wherein the software modules in the Application Ad Library enable a Publisher to provide, for example and without limitation, cost-per-lead (“CPL”) advertising (i.e., where a user signs up, and thereby, provides a lead, and the Publisher is compensated for each such lead) inside the mobile app. As used herein, the term Application Ad Library and software modules in the Application Ad Library are used to refer to software modules in the Application Ad Library. In accordance with one or more such embodiments of the present disclosure, the Application Library enables Ad Units obtained from an Ad Server to collect user lead data (for example and without limitation, self-reported, personal information data) for multiple Advertisers within an Ad Unit. In accordance with one or more such embodiments, the user is enabled to select one, or more than one, Advertiser's offer by selecting checkboxes displayed within the Ad Unit on the mobile device display. Then, the user may submit the data by “clicking” a submit button (as used herein the term clicking means clicking a mouse, depressing a finger on a touch screen, and any way an indication of a selection can be made using a mobile device), and the Application Ad Library causes the mobile device to send the data automatically to the Advertiser(s), for example, and without limitation, via a data transfer system such as the Pontiflex™ data transfer system available from Pontiflex, Inc. of Brooklyn, N.Y. Thus, in accordance with one or more such embodiments, a user can opt-in to an Advertiser's marketing program by providing her/his contact information to that Advertiser. In accordance with one or more such embodiments, the software modules in the Application Ad Library are executed on the mobile device as part of the mobile app so that the user does not need to leave the mobile app to interact with the Ad Units. Therefore, the user can sign up and quickly return to the mobile app.

One or more embodiments of the present disclosure are useful to mobile app Developers, Advertisers, Publishers and Consumers. Developers benefit by being able to be compensated when users opt-in to ads. Advertisers benefit by being able to collect interested customers' contact information (so-called “lead data”) instead of having customers' click and being re-directed to a website, which re-direction might never convert into the customers taking an action or signing-up—beneficially, lead data can be reused and remarketed. Publishers benefit by receiving a higher payout for their advertising real estate—most Internet Publishers rely on advertising to fund their operations, and a drop in yields from advertising revenue can adversely affected many Publishers. In accordance with one or more embodiments of the present disclosure, because a consumer can select multiple Advertisers' offers within the same Ad Unit, the Publisher can be paid by multiple Advertisers rather than just one—thereby multiplying the yield of an Ad Unit. When a consumer selects more than one offer this can multiply the payout the Publisher obtains from that Ad Unit (based, for example, on how many offers the consumer selects). Users (or consumers) benefit for several reasons. Users (or consumers) can opt-in to multiple Advertisers' offers instead of having to find and opt-in one-at-a-time—thereby gaining convenience and efficiency. Users (or consumers) are not redirected away from their mobile app because they are opting-in to receive information from the Advertiser(s) in their mobile app, and they are not being driven directly to an Advertiser's website.

One or more embodiments of the present disclosure use a Pontiflex™ data transfer system (described for example, in a U.S. patent application entitled “System and Method for Connecting and Managing Data Transfers Over the Internet,” having application Ser. No. 11/801,330, which application was filed May 9, 2007, was published as U.S. Publication No. 2007/0294133A1, and is assigned to the assignee of the present patent application, which patent application and publication are incorporated by reference herein, and which patent application is referred to herein as the “Pontiflex Application”) to manage routing and delivery of data from Ad Units to various Advertisers. Relevant aspects of the Pontiflex™ data transfer system are described herein in the Appendix. Beneficially, by using the Pontiflex™ data transfer system, data is delivered directly from Ad Units in a mobile application to Advertiser(s) with no additional work required by Publishers.

As described in the Appendix, and as shown in FIG. 1 (this is also FIG. 1 of the Pontiflex Application), the Pontiflex™ data transfer system is a computer system (computer system 1000) that provides a data bridge connecting Publishers (a Publisher is also referred to herein as a “data source” and may include a computer system or a mobile device referred to as a Publisher computer system or as a Publisher) to Advertisers (an Advertiser is also referred to herein as a “data consumer” and may include a computer system referred to as an Advertiser computer system or as an Advertiser) to transfer data between them as well as Publishers to Developers. In particular, the Pontiflex™ data transfer system mediates data transfers so that data sources (i.e., computer systems and mobile devices) can connect to computer system 1000 (shown in FIG. 1) in their preferred data transfer protocols to send data, and data consumers (i.e., computer systems) can build connections to computer system 1000 in their preferred data transfer protocols to receive data. By converting data received from data sources into data sent to data consumers, computer system 1000 provides a flexible “data bridge” that enables simple connectivity between parties, immediate delivery of customer data, and lowered cost of doing business.

As further described in the Appendix, computer system 1000 integrates online data transfers (typically comprised of data provided by consumers such as, for example and without limitation, name, email address, zip code, credit card number, or other information) between Publishers and Advertisers using a set up process. Once the set up process is complete, computer system 1000 translates data received from a Publisher (i.e., a data source) and sends the data to an Advertiser (i.e., a data consumer) by automatically recognizing a data output format provided by the Publisher and converting that information into a data input format required by the Advertiser.

As further described in the Appendix, a data source has an option to send data to computer system 1000 using a BrowserScriptPost code snippet that is generated by computer system 1000, and is available to be downloaded by the data source via a computer-system-provided web interface (alternatively, computer system 1000 may provide the BrowserScriptPost code snippet by email or a user of computer system 1000 may cause the BrowserScriptPost code snippet to be downloaded manually).

User Interaction Flow:

The Application Ad Library enables developers of mobile applications for use, for example and without limitation, with smartphones like the Apple® iPhone® mobile digital device, the Motorola® Droid mobile phone, and so forth to connect with Advertisers. In accordance with one or more embodiments of the present disclosure, an Ad Server computer system (also referred herein as an Ad Server) serves advertising from Advertisers to mobile apps running on mobile devices during users (or customers) usage of the mobile apps. As is described herein, software modules in the Application Ad Library run in the mobile app executing on the mobile device, and ask for Ads to be served to the mobile app from the Ad Server computer system (as will explained below, the Ad Server computer system can optimize the choice of Ads to serve), and, when a user opts-in to such Ads, software modules in the Application Ad Library cause the mobile device to send this information to a data transfer system. The data transfer system, in turn, sends the information to the Advertisers.

As one of ordinary skill in the art can readily appreciate, mobile apps and software modules that execute within mobile apps are software modules that execute on mobile device hardware such as, for example and without limitation, mobile device CPU(s), mobile device memory, mobile device data storage, mobile device display apparatus, and mobile device user input device such as keyboard and/or touch screen.

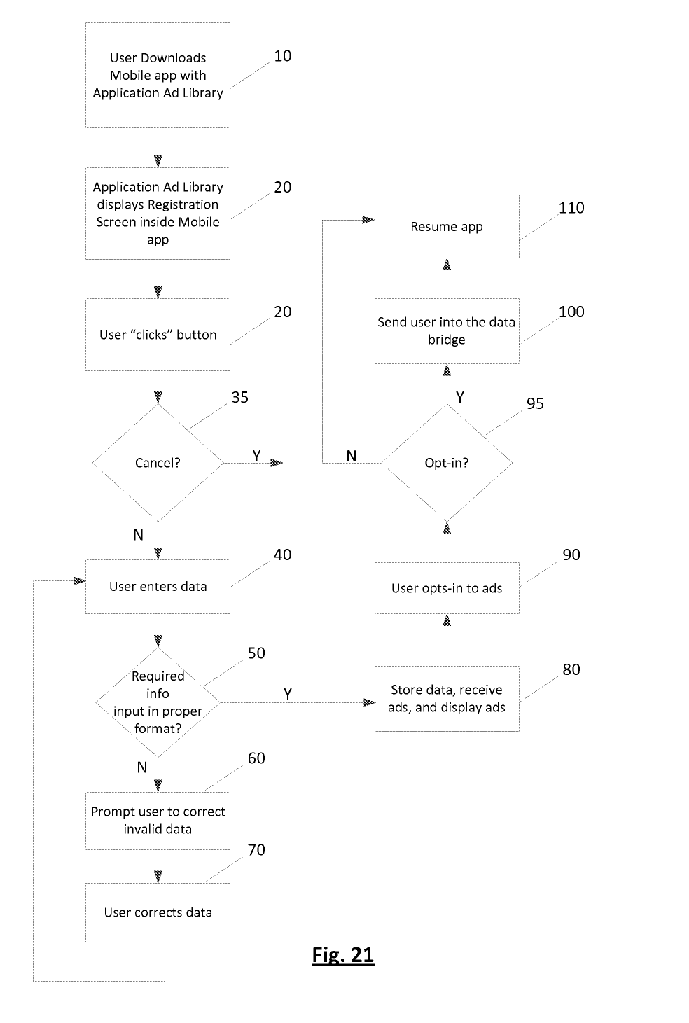

FIG. 21 is a flow diagram showing a sequence of events from a user's perspective as the user interacts with an Ad Unit presented within a mobile device application, which Ad Unit and which method of user interaction are fabricated in accordance with one or more embodiments of the present disclosure. At step 10 shown in FIG. 21, the user causes the mobile device to download and install a mobile application (“mobile app”) on the mobile device, which mobile app includes an Application Ad Library that has been fabricated in accordance with one or more embodiments of the present disclosure. The manner in which a user causes these actions by a mobile device, and any one of a number of methods for embodying these actions, are well known to those of ordinary skill in the art. Then, control is transferred to step 20.

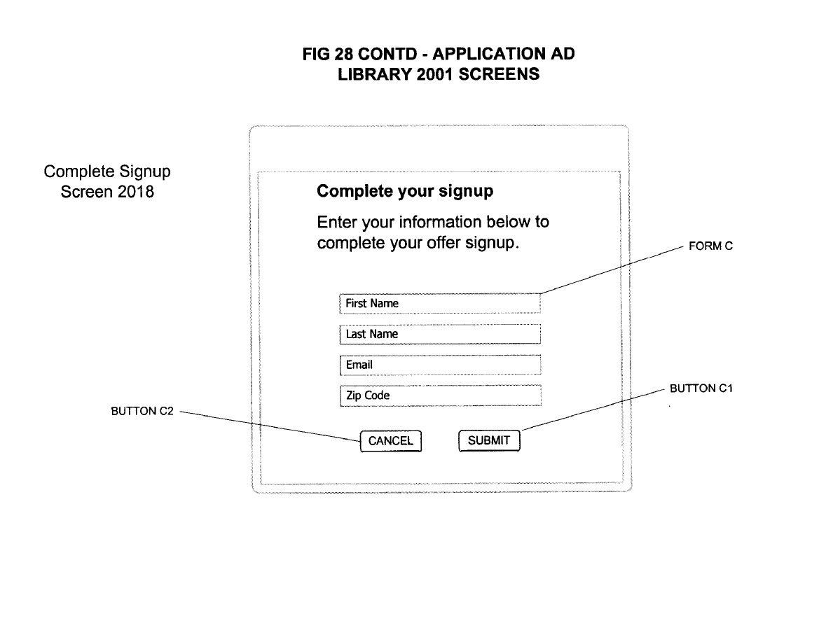

At step 20 shown in FIG. 21, the user causes the mobile device to execute the mobile app (the manner in which a user causes this action by a mobile device, and any one of a number of methods for embodying this action, are well known to those of ordinary skill in the art), and the Application Ad Library displays a registration screen that was created by an application Developer on a mobile device display, for example and without limitation, a touch screen display, as will be described below, in accordance with one or more embodiments of the present disclosure. Control is then transferred to step 30. FIG. 28 shows Registration Screen 2016 that is displayed on the user's mobile device by the Application Ad Library. In accordance with one or more embodiments, Registration Screen 2016 is configurable by the application Developer, and in particular, the Developer can choose which fields have data that is collected during a registration process.

As shown in FIG. 28, Registration Screen 2016 may include a Registration Offer Headline, Registration Offer creative material such as, for example and without limitation, an advertiser logo or other such information such as a trademark, and text which may be a message providing the user with a reason to sign up on the registration page. As further shown in FIG. 28, Registration Screen 2016 may include data capture fields for user registration, which data capture fields may include, for example and without limitation, name (for example, first name and last name), email address, and zip code. As further shown in FIG. 28, the Developer may also provide a method for the user to indicate s/he wishes to skip the registration screen. For example, the Developer may enable the user to skip registration by, for example and without limitation, clicking a “cancel” button using a mobile device user input device such as, for example and without limitation, a keyboard displayed on a touch screen or a keyboard input.

At step 30 shown in FIG. 21, the user clicks a button using the mobile device user input device, and control is transferred to decision step 35 shown in FIG. 21.

At decision step 35 shown in FIG. 21, the Application Ad Library determines whether the user clicked on cancel button A2 shown on Registration Screen 2016 in accordance with any one of a number of methods that are well known to those of ordinary skill in the art. If so, control is transferred to step 110 shown in FIG. 21, otherwise, control is transferred to step 40 shown in FIG. 21.

At step 40 shown in FIG. 21, the user enters data into the data capture fields shown on Registration Screen 2016 using the mobile device user input device, and clicks on submit button A1 shown on Registration Screen 2016 using the mobile device user input device. Control is then transferred to decision step 50 shown in FIG. 21.

At decision step 50 shown in FIG. 21, the Application Ad Library validates the data, i.e., it determines whether all the required information has been entered and whether the information entered is appropriate (for example, whether the zip code and email address conform to an appropriate formats and so forth). If more information is needed or if the entered information is not appropriate, control is transferred to step 60 shown in FIG. 21, otherwise, control is transferred to step 80 shown in FIG. 21. In addition, if the user does not complete the registration page, control is transferred to step 110 shown in FIG. 21. However, in this case, the registration page may be displayed again after a configurable number of executions of the app executions.

At step 60 shown in FIG. 21, the Application Ad Library prompts the user to correct invalid data by displaying a message on the mobile device display. Then, control is transferred to step 70 shown in FIG. 21.

At step 70 shown in FIG. 21, the user corrects the information on the registration screen and clicks the submit button, i.e., button A1 using the mobile device user input device. Then, control is transferred to step 50 shown in FIG. 21.

At step 80 shown in FIG. 21, the Application Ad Library stores the registration data, for example and without limitation, in encrypted form, inside the mobile application. Alternatively, the Application Ad Library transfers the registration data to the Ad Server. In addition, the Application Ad Library contacts the Ad Server, and in response, the Ad Server sends one or more advertisements, for example and without limitation, opt-in advertisements, from Advertiser(s), to the Application-Ad Library for display on the mobile device. Next, the Application Ad Library displays the one or more advertisements on the mobile device. The mobile ads may be displayed in a variety of sizes. For example and without limitation, in accordance with one or more embodiments of the present disclosure, ads would appear at the bottom of an app screen in a rectangle. In accordance with one or more further embodiments, ads would appear at the top of the app screen or ads may appear to take over the entire screen between app actions. As shown in FIG. 28, Ad Screen 2017 may include a number of offer blocks where an offer block may include (a) an offer headline; (b) offer creative material which, for example and without limitation, describes the Advertiser's product or service and invites the user to opt-in to the advertisement to receive more information on the product or service (this may also be referred to as an “opt-in offer”); and (c) a checkbox, a portion of a display where the user may (by appropriate input such as, for example and without limitation, by clicking on a box) indicate a desire to accept the opt-in offer (this “checkbox” may also be referred to as an “opt-in checkbox”). As further shown in FIG. 28, Ad Screen 2017 includes a cancel button B2 that the user may use to return the application screen real estate back to the mobile app and resume normal execution of the mobile app; and, in accordance with one or more further embodiments, Ad Screen 2017 includes a button, button B1, that the user may use to opt-into the ads. Next, control is transferred to step 90 shown in FIG. 21.

At step 90 shown in FIG. 21, the user may or may not click one or more offer opt-in checkboxes to opt-in to the advertisers' offers. Then, the user clicks submit button B1 to continue with the mobile app. Next, control is transferred to step 95 shown in FIG. 21.

At step 95 shown in FIG. 21, the Application Ad Library determines whether the user has opted-in to one or more advertisements. If, not, control is transferred to step 110 to resume normal execution of the app, otherwise control is transferred to step 100 shown in FIG. 21.

At step 100 shown in FIG. 21, the Application Ad Library sends user information from the registration process for the ads opted-in to Advertisers, for example, it sends the user information to a data bridge for transfer to Advertisers. Then, control is transferred to step 110 shown in FIG. 21.

At step 110 shown in FIG. 21, the mobile app resumes running.

In accordance with one or more further embodiments of the present disclosure, a registration page is not presented, only ads are presented to the user in the manner described above. In accordance with one or more such embodiments, the user may opt-in to one or more such ads, and when the user clicks the submit button, a “complete sign-up screen 2019 shown in FIG. 28. The user enters information and the information is checked as described above with respect to the registration page. Once again, the user may decide to cancel any opt-in by clicking the cancel button, button C2, or the user may decide to submit the sign-up. If the user has signed up, the Application Ad Library will send the user information for the ads opted-into to the Ad Server as described above, and the mobile app will resume.

Ad Server Computer System

In accordance with one or more embodiments of the present disclosure, an Ad Server computer system (also referred to herein as an Ad Server), for example and without limitation, a Pontiflex™ Ad Server computer system available from Pontiflex, Inc. of Brooklyn, N.Y., is a system that transmits advertisements from Advertisers in the form of various Ad Units to a mobile device for display thereon within a mobile app. In accordance with one or more such embodiments of the present disclosure, an Ad Unit displayed on the mobile device may include advertisements from one or more Advertisers at the same time, and software modules from an Application Ad Library running in the mobile app enable a user to opt-into one or more of the advertisements and to provide his/her personal information (for example and without limitation, name, email address and telephone number). In accordance with one or more such embodiments of the present disclosure, user interaction with an Ad Unit triggers code, for example and without limitation, BrowserScriptPost code (described below in the Appendix), that executes within the app, which code sends user data to Advertiser(s) via a data transfer system or data bridge such as, for example and without limitation, the Pontiflex™ data transfer system of computer system 1000 which is described below in the Appendix.

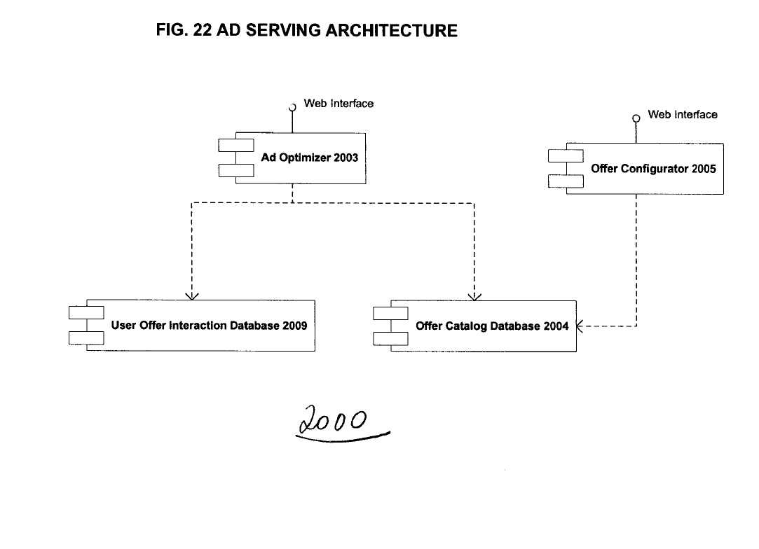

FIG. 22 is a block diagram of Ad Server computer system 2000 that is fabricated in accordance with one or more embodiments of the present disclosure. As shown in FIG. 22, in accordance with one or more embodiments of the present disclosure, Ad Server computer system 2000 comprises: (a) Ad Optimizer 2003, (b) Offer Catalog Database 2004, (c) Offer Configurator 2005; and (d) User Offer Interaction Database 2009. These modules of Ad Server computer system 2000 execute, for example and without limitation, on a computer system (for example and without limitation, a centralized computer system) that may be accessed/used by a number of Advertisers. As one of ordinary skill in the art can readily appreciate, Ad Optimizer 2003, Offer Catalog Database 2004, Offer Configurator 2005 and User Offer Interaction Database 2009 are combinations of software modules and computer hardware that provide functionality that will be described in detail below. In particular, computer system 2000 may include one or more computers, each of which includes computer hardware such as, for example and without limitation, one or more CPUs, memory (for example random access memory), data stores in the form of computer disks unit(s) and/or solid state storage, Internet interface equipment, communications interfaces, user interfaces such as user monitors and CRT displays or flat panel displays or touch screen displays and so forth, user input devices such as keyboards, and so forth. As one of ordinary skill in the art can readily appreciate, Ad Optimizer 2003, Offer Catalog Database 2004, Offer Configurator 2005 and User Offer Interaction Database 2009 may comprise software modules executing on the same computer or may comprise software modules executing on one or more different computers, and the data stores may utilize storage hardware associated with the same computer or one or more different computers.

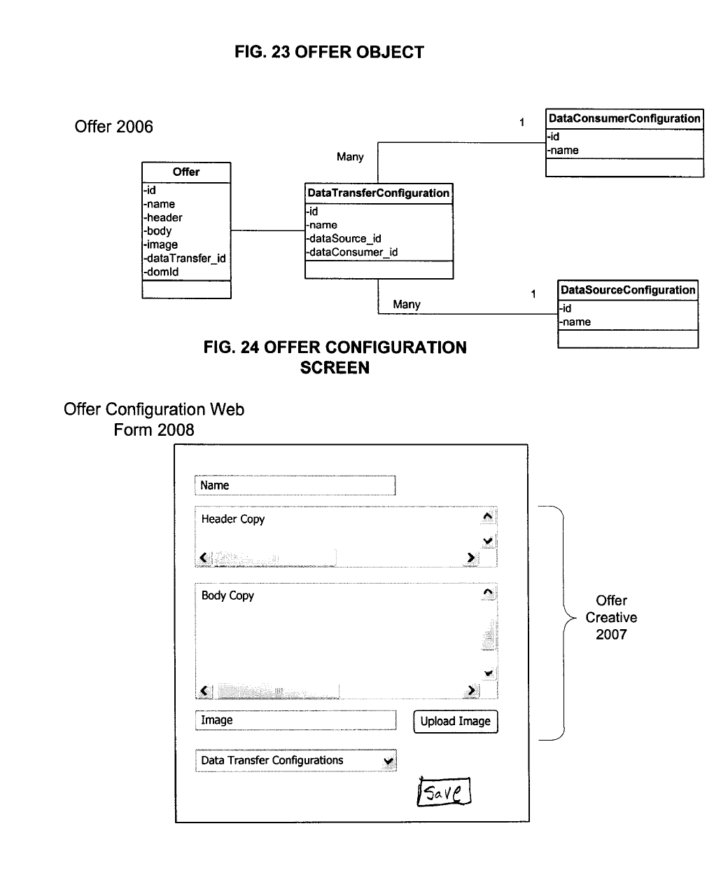

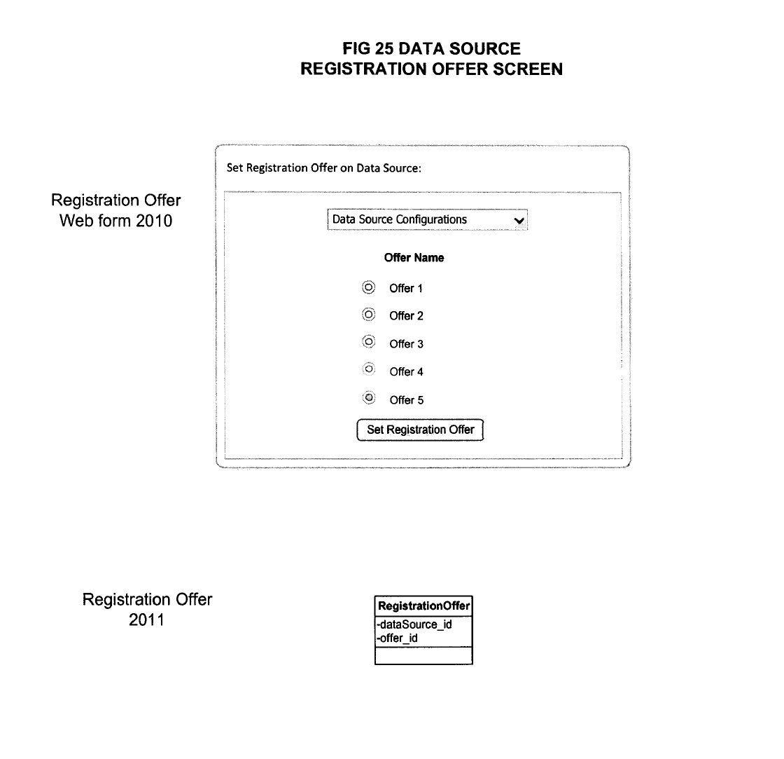

In accordance with one or more embodiments of the present disclosure, Offer Configurator 2005 shown in FIG. 22 is a module of Ad Server computer system 2000, and Offer Configurator 2005 provides a web interface that is used by an Advertiser to create an Offer object. In accordance with one or more such embodiments, the web interface provides Offer Configuration web form 2008 shown in FIG. 24 that has been fabricated in accordance with one or more embodiments of the present disclosure. As used herein, an Offer object is a singular instance of an advertisement that is created by an Advertiser to be run in a mobile app on a mobile device. FIG. 23 shows Offer object 2006 that has been fabricated in accordance with one or more embodiments of the present disclosure, and its relationship to a Data Transfer Configuration that is created by an Advertiser using the Pontiflex™ data transfer system (as described in the Appendix in conjunction with the Pontiflex application).

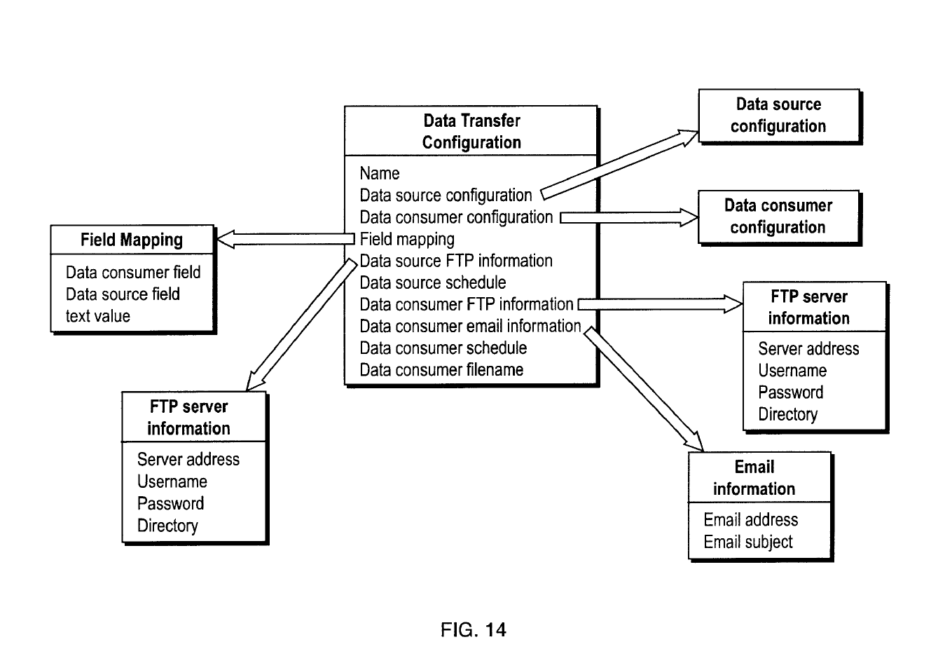

In accordance with one or more embodiments of the present disclosure, as shown in FIG. 23, Offer object 2006 typically includes various pieces of text that are collectively referred to as an “Offer Creative.” In accordance with one or more such embodiments, an Offer Creative may also include one or more image(s). Offer Creative 2007 of Offer Configuration web form 2008 shown in FIG. 24 comprises a portion of Offer Configuration web form 2008 used for entering the components of an Offer Creative. In accordance with one or more such embodiments of the present disclosure, Offer object 2006 also includes an id for a Data Transfer Configuration, i.e., “dataTransfer_id,” (Data Transfer Configuration is described in the Appendix in conjunction with FIG. 14, this is also FIG. 15 of the Pontiflex application) that was created previously by the Advertiser using the Pontiflex™ data transfer system of computer system 1000. The Data Transfer Configuration links: (a) an Advertiser's Data Consumer Configuration (described in the Appendix in conjunction with FIG. 13, this is also FIG. 14 of the Pontiflex application) with (b) a Publisher's Data Source Configuration (described in the Appendix in conjunction with FIG. 12, this is also FIG. 13 of the Pontiflex application). The Advertiser's Data Consumer Configuration is created by the Advertiser using a web interface of Advertiser Export Configurator 100 of the Pontiflex™ data transfer system of computer system 1000 (as described in the Appendix in conjunction with FIG. 1, this is also FIG. 1 of the Pontiflex application). The Publisher's Data Source Configuration is created by the Publisher using a web interface of Publisher Import Configurator 200 of the Pontiflex™ data transfer system of computer system 1000 (as described in the Appendix in conjunction with FIG. 1, this is also FIG. 1 of the Pontiflex application). The Data Transfer Configuration is created by the Advertiser using a web interface of Data Transfer Configurator 300 of the Pontiflex™ data transfer system of computer system 1000 (as described in the Appendix in conjunction with FIG. 1, this is also FIG. 1 of the Pontiflex application). As further described in the Appendix, the Data Source Configuration, the Data Consumer Configuration and the Data Transfer Configuration are stored in a configuration data store 250 of computer system 1000 (as described in the Appendix in conjunction with FIG. 1, this is also FIG. 1 of the Pontiflex application, which configuration data store 250 is accessible by Ad Server computer system 2000.

In accordance with one or more embodiments of the present disclosure, to create an Offer object using Offer Configuration web form 2008, an Advertiser: (a) enters a name for the Offer which is used by the Advertiser to identify the Advertising Offer (i.e., it is a human readable identifier of the Advertising Offer in Offer Catalog Database 2004—the name does not have to be unique in the database, it ought to be just different enough for the Advertiser to visually identify it from other offers the Advertiser has created); (b) enters Offer Creative—this typically includes text for a header, text for a body and an optional image; (c) selects one Data Transfer Configuration (stored in configuration data store 250) the Advertiser has created, for example, and without limitation, using a drop down menu. Next, Offer Configurator 2005 creates a numeric id (“id”) which may also serve as an identifier of Offer object 2006 in Offer Catalog Database 2004. Then, the Advertiser clicks on a Save button, at which instance, Offer Configurator 2005 creates and saves the new Offer object in Offer Catalog database 2004 shown in FIG. 22.

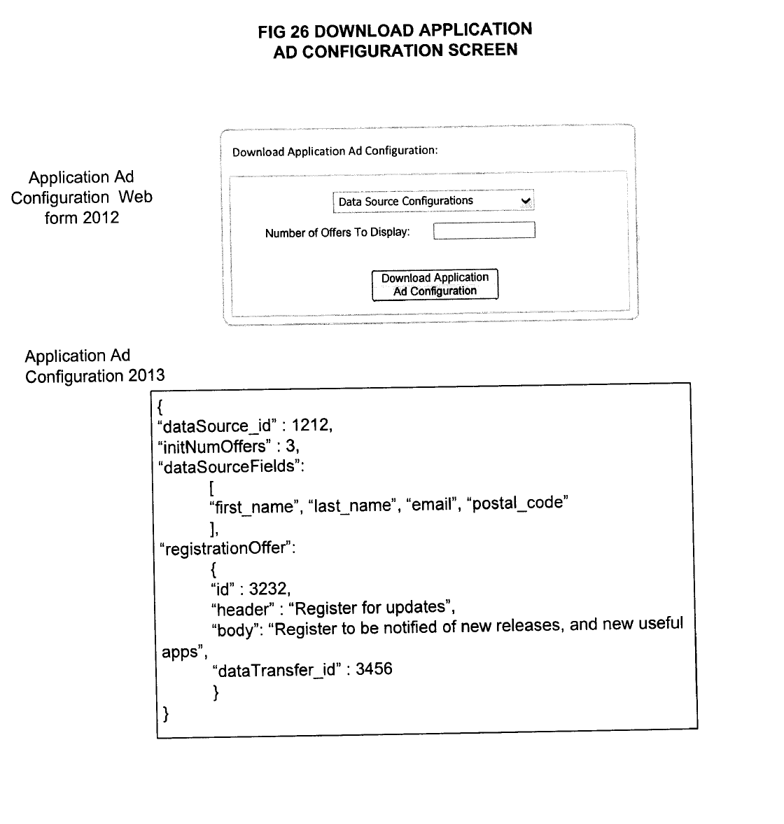

A Publisher and/or Developer (referred to here as Publisher/Developer) can create an offer for itself (thereby allowing users to register to the Publisher/Developer so the Publisher/Developer can see who is using the app by carrying out the following steps. Step 1, the Publisher/Developer accesses Data Export Configurator 100 of the Pontiflex™ data transfer system of computer system 1000 (as described in the Appendix in conjunction with FIG. 1, this is also FIG. 1 of the Pontiflex Application) which the Publisher/Developer uses to create a Data Consumer Configuration. Step 2, the Publisher/Developer creates a Data Transfer Configuration using a web interface of Data Transfer Configurator 300 of the Pontiflex™ data transfer system of computer system 1000 (as described in the Appendix in conjunction with FIG. 1, this is also FIG. 1 of the Pontiflex Application). To create the Data Transfer Configuration, the Publisher/Developer selects the Data Consumer Configuration created in Step 1 above, and selects one of its Data Source Configurations. Step 3, the Publisher/Developer creates an Offer object using Offer Configuration web form 2008, by: (a) entering a name for the Offer which is used by the Publisher/Developer to identify the Advertising Offer (i.e., it is a human readable identifier of the Advertising Offer in Offer Catalog Database 2004); (b) entering Offer Creative—this typically includes text for a header, text for a body and an optional image; and (c) selecting one Data Transfer Configuration created in Step 2 above. The Publisher/Developer then uses Registration Offer web form 2010 shown in FIG. 25 provided by Offer Configurator 2005 by a selecting the Data Source Configuration used while creating the Data Transfer Configuration in Step 2 above. Offer Configurator 2005 displays a list of all offers that are associated with Data Transfer Configurations which are associated with the selected Data Source Configuration. The Publisher/Developer then selects the Offer object created in Step 3 above, and clicks on the “Set Registration Offer” button in Registration Offer web form 2010. Offer Configurator 2005 then: (a) creates RegistrationOffer object 2011 (refer to FIG. 25) where: (i) the value of the key “offer_id” is set to the selected offer, and (ii) the value of the key “dataSource_id” is set to the Data Source Configuration selected in Step 2, and (b) saves the RegistrationOffer object in Offer Catalog Database 2004.

In accordance with one or more embodiments of the present disclosure, Ad Optimizer 2003 shown in FIG. 22 is a module of Ad Server computer system 2000, and Ad Optimizer 2003 provides a web interface that, upon request, returns a list of Offers from Offer Catalog database 2004 that a consumer is most likely to select (in light of the information and techniques used to provide the list) when presented to him/her in an Ad Unit. In accordance with one or more such embodiments, the list of Offers is returned in a format that can be read by Application Ad Library 2001, and in accordance with one or more such embodiments, the list is returned as a JSON formatted string, where JSON (JavaScript Object Notation) is a lightweight data-interchange format. JSON is based on a subset of the JavaScript Programming Language, Standard ECMA-262 3rd Edition—December 1999. A JSON formatted string is easy for humans to read and write, and is easy for machines to parse and generate. JSON is a text format that is language independent but uses conventions that are familiar to programmers of the C-family of languages, including C, C++, C#, Java, JavaScript, Perl, Python, and many others.

In accordance with one or more embodiments of the present disclosure, inputs (which inputs are provided as described in detail below) to a web interface provided by Ad Optimizer 2003 are: (a) an id of a Data Source Configuration; (b) a list of zero or more keywords (for example and without limitation, a list of plain text words separated by commas) which describe the application's content (for example, an app Developer might provide such a list of keywords); where such keywords help enable (as described below) the selection of relevant offers which are contextual to the application's content, and which offers therefore, might yield a higher response rate for an advertisement; (c) a unique mobile application installation identifier; (d) zero or more ids of Offers which represent a list of Offers a user had selected; and (e) an integer representing the number of Offers Ad Optimizer 2003 should return (i.e., a number of requested Offers). Then, in response, Ad Optimizer 2003 uses the id of the Data Source Configuration to determine an initial list of Offers that are present in Offer Catalog database 2004 which use a Data Transfer Configuration that uses the Data Source Configuration by querying Offer Catalog Database 2004 using a database query language such as, for example and without limitation, SQL. In accordance with one or more embodiments of the present disclosure, Ad Optimizer 2003 returns a list of the retrieved Offers (restricting the list to include no more than the number of requested Offers). In accordance with one or more alternative embodiments, Ad Optimizer 2003 filters the list of Offers down to a list of Offers that are more likely to be selected by users in an Ad Unit using commonly available techniques such as, for example and without limitation, Contextual Targeting, Behavioral Targeting or Collaborative Filtering. In accordance with one or more such alternative embodiments of the present disclosure, Ad Optimizer 2003 uses the list of keywords, if present, and applies Contextual Targeting techniques that are well known to those of ordinary skill in the art to determine which Offers are more likely to be selected by a user in the context of the application's content. In accordance with one or more further such alternative embodiments of the present disclosure, Ad Optimizer 2003 uses the optional, non-personally identifying mobile application installation identifier and applies Behavioral Targeting techniques that are well known to those of ordinary skill in the art to determine automatically which Offers are more likely to be selected by a user based on his/her previous interactions (i.e., selected previously) with other Offers in accordance with any one of a number of commonly available embodiments of Behavioral Targeting techniques. In accordance with one or more still further such alternative embodiments of the present disclosure, Ad Optimizer 2003 applies Collaborative Filtering techniques that are well known to those of ordinary skill in the art to determine automatically which Offers are more likely to be selected in the context of the Offers which have been already selected by the user in accordance with any number of commonly available embodiments of collaborative filtering techniques. In accordance with one or more embodiments of the present disclosure, data relating to Offers selected by a user were transmitted by AdManager 2014 (to be described in detail below) to Ad Optimizer 2003, and Ad Optimizer 2003 stored the data in User Offer Interaction Database 2009 of Ad Server system 2000 (refer to FIG. 22).

Application Ad Library 2001

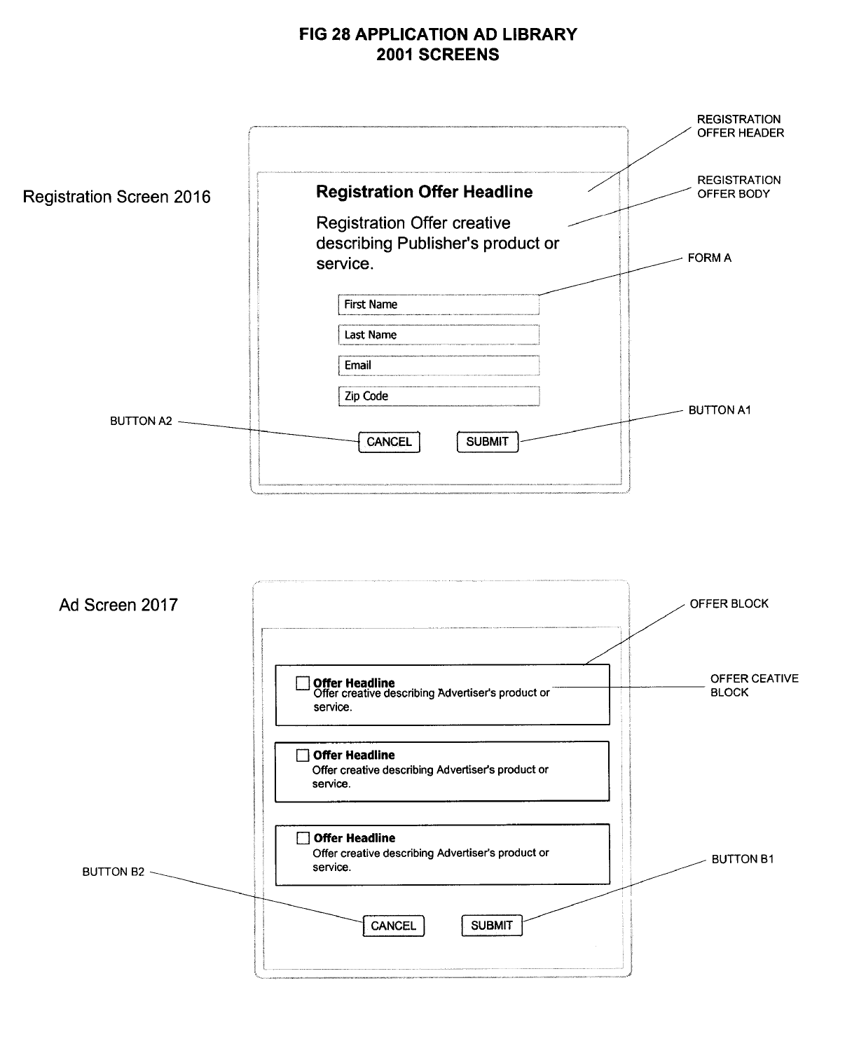

In accordance with one or more embodiments of the present disclosure, Application Ad Library 2001 shown in FIG. 27 is provided as an Application Programming Environment compatible SDK (“System Development Kit”) to a Developer. In accordance with one or more such embodiments, Application Ad Library 2001 may be provided, for example and without limitation, as a JAR file for Android, as an Application Bundle for OSX/iOS, as a DLL or .NET Assembly for WindowsXP/Vista/7, or as a Silverlight Assembly for Windows Phone 7. In accordance with one or more such embodiments of the present disclosure, the Developer packages the Application Ad Library 2001 inside his/her application using a standard Application Programming Environment procedure such as, for example and without limitation, by copying the JAR file into the “assets” folder for an Android Application or by copying the Application Bundle into the iOS XCode project of an iOS Application.

In accordance with one or more embodiments, Application Ad Library 2001 contains AdManager 2014 (refer to FIG. 27), and it utilizes an Application Operating System provided Application Secure Data Store 2015 (refer to FIG. 27). Typical examples of Application Secure Data Store 2015 are Keystores in Android, Keychain in OSX/iOS, Silverlight Isolated Storage in Windows Phone 7, and Secure Registry Keys for WindowsXP/Vista/7. In accordance with one or more such embodiments, Application Secure Data Store 2015 provides an encrypted storage space that is isolated to the Application Scope, i.e. another application installed on the same mobile device cannot access or read the contents of Application Secure Store 2015, and only the Application is able to add/update contents of Application Secure Data Store 2015. Application Secure Data Store 2015, across all Operating Systems, can be abstracted (i.e., thought of) as a key-to-value map type storage.

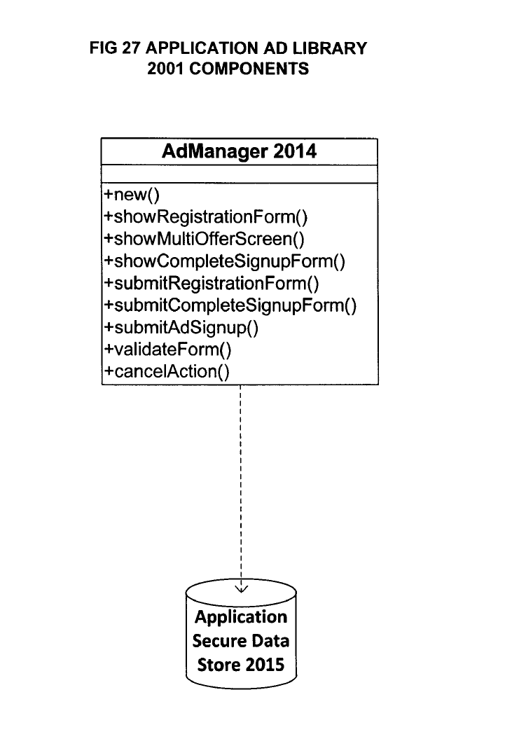

To configure an Ad Unit, a Developer uses Offer Configurator 2005 of Ad Server computer system 2000 to obtain Application Ad Configuration web form 2012 that is fabricated in accordance with one or more embodiments, an embodiment of Application Ad Configuration Web Form 2012 is shown in FIG. 26. Next, using Application Ad Configuration Web Form 2012, the Developer: (a) selects a Data Source Configuration; (b) enters the number of advertiser offers to display to the user; and (b) clicks on the “Download Application Ad Configuration Screen.” In response, Offer Configurator 2005 of Ad Server computer system 2000 creates Application Ad Configuration 2013 that is fabricated in accordance with one or more embodiments, an embodiment of Application Ad Configuration web form 2012 is shown in FIG. 26. In accordance with one or more such embodiments, Application Ad Configuration 2013 is generated in JSON format by: (a) setting the value of the key “dataSource_id” to the id of the Data Source Configuration selected in Application Ad Configuration Web Form 2012; (b) setting the value of the key “initNumOffers” to the value entered for the “Number of Offers To Display” in Application Ad Configuration Web Form 2012; (c) setting the array “dataSourceFields” to an array consisting of the names of the fields contained in the Data Source Configuration; and (d) if there is to be a registration offer, setting the value of the key “registrationOffer” to the Registration Offer selected for the Data Source Configuration by the Publisher/Developer using Registration Offer Web Form 2010. Then, Application Ad Configuration 2013 is provided to the Developer, for example and without limitation, as a downloaded file.

In accordance with one or more such embodiments, the Developer then packages Application Ad Configuration 2013 inside the desired app using Application Programming Environment packaging mechanisms that are well known to those of ordinary skill in the art so that Application Ad Configuration 2013 is packaged, for example and without limitation, in the “assets” folder of an Android Application, in the “Resources” folder of an iOS Application, and so forth.

As one of ordinary skill in the art can readily appreciate, the AdManager component (for example, AdManager 2014 shown in FIG. 27) of the Application Ad Library (for example, Application Ad Library 2001 shown in FIG. 27) is used to provide the user experience in terms of presenting and interacting with advertising on his/her mobile device within a mobile app. As such, the experience can be changed in accordance with the desire of the Developer by using the Application Ad Library SDK to change the AdManager component, for example by rearranging the order in which routines are called, by adding new routines or by omitting routines.

Operational Mode 1: Show Registration Screen followed by Ad Screen

To effectuate an operational mode (Operational Mode 1) where a Registration Screen is displayed, followed by an Ad Screen, the Developer creates a new instance of AdManager 2014 (refer to FIG. 27) by invoking the “new” method of the mobile device operating systems on AdManager 2014 in his/her Application Code. The Application Code then invokes the function showRegistrationForm( ) of AdManager 2014, typically this is done immediately after the Application is launched.

In accordance with one or more embodiments of the present disclosure, function showRegistrationForm( ) checks if Application Secure Data Store 2015 contains data object 901 (described in the Appendix). If Application Secure Data Store 2015 contains data object 901, showRegistrationForm( )) invokes the function showMultiOfferScreen( ) of AdManager 2014, and function showRegistrationForm( ) exits. If Application Secure Data Store 2015 does not contain data object 901, function showRegistrationForm( ) draws Registration Screen 2016 (refer to FIG. 28)—Registration Screen 2016 is fabricated in accordance with one or more embodiments of the present disclosure—using native screen elements provided by the Application Programming Environment in accordance with any one of a number of methods that are well known to those of ordinary skill in the art. In particular, showRegistrationForm( ) reads Application Ad Configuration 2013 (refer to FIG. 26). Then, showRegistrationForm( ) creates a native text element “Registration Offer Headline,” and sets its value to the “header” value of the “registrationOffer” element in Application Ad Configuration 2013. Next, showRegistrationForm( ) creates a text element “Registration Offer Body,” and sets its value to the “body” value of the “registrationOffer” element in Application Ad Configuration 2013. Next, function showRegistrationForm( ) creates “Form A” shown in FIG. 28 by creating native input text boxes for each of the fields listed in “dataSourceFields” in Application Ad Configuration 2013. Next, showRegistrationForm( ) creates “Button A 1” shown in FIG. 28, and sets the onclick event for Button A1 to invoke function submitRegistrationForm( ) of AdManager 2014. Next, showRegistrationForm( ) creates “Button A2” shown in FIG. 28, and sets the onclick event for Button A2 to invoke function cancelAction( ) of AdManager 2014. Function showRegistrationForm( )) also stores the value of the “id” and “dataTransfer_id” of the “registrationOffer” element in Application Ad Configuration 2013 in the “view state storage” of Registration Screen 2016. As is well known, “view state storage” is storage provided by the Application Programming Environment that a screen can use to store its state during an instantiation of the screen's being visible to the user and the user's subsequent interaction with the screen. The “view state storage” is erased between separate invocations of the screen so that data stored in the “view state storage” is not persisted between invocations. In accordance with one or more embodiments of the present disclosure, if a user clicks on “Button A2,” Registration Screen 2016 invokes the function cancelAction( ) of AdManager 2014, and function cancelAction( ) closes and removes Registration Screen 2016.

In accordance with one or more embodiments of the present disclosure, if a user clicks on “Button A1,” Registration Screen 2016 invokes function submitRegistrationForm( ) of AdManager 2014. In accordance with one or more such embodiments, function submitRegistrationForm( ) executes the following steps. Function submitRegistrationForm( ) executes function validateForm( ) of AdManager 2014 which executes the following steps. Function validateForm( ) checks whether the user has entered information for all input fields inside form “FormA.” In addition, if the input fields inside form “FormA” include an Email field, function validateForm( )) of AdManager 2014 verifies that the value conforms to a valid “Email” syntax. In further addition, if the Developer chooses to restrict users to be residents of a particular country, and the input fields inside form “FormA” include a Postal Code field (for example, Zip Code in the United States), function validateForm( ) of AdManager 2014 verifies that the value conforms to a valid “PostalCode” syntax for that country. An example of this would be to check whether the “PostalCode” value is a five (5) digit number if the country is the United States. If these checks do not pass, a native “alert” notification box is called with a message informing the user that he/she has to correct a corresponding input field, and function validateForm( ) of AdManager 2014 returns “false.” If all checks pass, function validateForm( ) of AdManager 2014 returns “true.”

Next, function submitRegistrationForm( ) of AdManager 2014 checks the return value of function validateForm( ) of AdManager 2014. If the return value of function validateForm( ) of AdManager 2014 is “false,” function submitRegistrationForm( ) of AdManager 2014 exits. If the return value of function validateForm( ) of AdManager 2014 is “true,” the process continues with the following steps.

In accordance with one or more embodiments of the present disclosure, function submitRegistrationForm( ) of AdManager 2014 creates an instance of data object 901 (refer to the Appendix and the Pontiflex Application). Next, function submitRegistrationForm( ) of Ad Manager 2014 obtains a list of all input elements inside form “FormA” in accordance with one or more methods that are well known to those of ordinary skill in the art. Next, for each of the input elements, function submitRegistrationForm( ) of AdManager 2014 adds a key and value pair in data object 901 (the key is the “id” key of the input element and the value is the “value” of the input element). Next, function submitRegistrationForm( ) of AdManager 2014 constructs and adds a request for an image file from computer system moo (refer to the Pontiflex application). The request for the image file is constructed as an HTTP GET request with the key and value pairs in data object 901 added in as parameters of the HTTP GET request. In addition, the key “dataTransfer_id” of the “registrationOffer” element in Application Ad Configuration 2013 is also added as a parameter of the HTTP GET request. The user data provided by the user's interacting with Registration Screen 2016 is thus collected and passed to computer system 1000 for onward transfer by computer system 1000 to the data consumer created by the Publisher/Developer specified in the data transfer configuration corresponding to the value of the key “dataSource_id” of Registration Offer 2011 (refer to FIG. 25).

Next, function submitRegistrationForm( ) stores data object 901 in Application Secure Data Store 2015. Next, function submitRegistrationForm( ) calls function showMultiOfferScreen( ) of Ad Manager 2014 and exits.

In accordance with one or more embodiments of the present disclosure, function showMultiOfferScreen( ) calls Ad Optimizer 2003 of Ad Server computer system 2000 through its web interface (refer to FIG. 22), and passes: (a) the value of the key “dataSource_id” in Application Ad Configuration 2013 (refer to FIG. 26) as the id of the Data Source Configuration; (b) a list of keywords representing the Application content, if available; and (c) the value of the key “initNumOffers” in Application Ad Configuration 2013 (refer to FIG. 26) as the number of offers to fetch. In response, and as described above, Ad Optimizer 2003 provides a list of Advertiser Offers in, for example and without limitation, JSON format, which list is received by function showMultiOfferScreen( ) Next, function showMultiOfferScreen( ) creates Ad Screen 2017 (refer to FIG. 28) that is fabricated in accordance with one or more embodiments of the present disclosure. For each Offer object in the list of Advertiser Offers received from Ad Optimizer 2003, showMultiOfferScreen( ) creates the “Offer Block” by creating a native text element and setting its value to the “header” value of the Offer object. Next, function showMultiOfferScreen( ) creates another native text element and sets its value to the “body” value of the Offer object. Next, function showMultiOfferScreen( ) creates a native checkbox element with the checkbox set to unselected state. Next, function showMutiOfferScreen( ) creates native button element “Button B1,” and sets the onclick event of Button B1 to invoke function submitAdSignup( ) of AdManager 2014. Next, function showMultiOfferScreen( ) creates another native button element, “Button B2,” and sets the onclick event of Button B2 to invoke function cancelAction( ) of AdManager 2014. If the user clicks on “Button B2,” Ad Screen 2017 invokes function cancelAction( ) of AdManager 2014. In response, function cancelAction( ) closes and removes Ad Screen 2017.

If the user selects one or more offers and clicks on “Button B1,” Ad Screen 2017 invokes function submitAdSignup( ) of AdManager 2014. In response, function submitAdSignup( ) checks if Application Secure Data Store 2015 contains data object 901.

If Application Secure Data Store 2015 contains data object 901, then for each checkbox in Ad Screen 2017, function submitAdSignup( ) checks if the user selected that checkbox. If a checkbox was selected, function submitAdSignup( ) constructs and adds a request for an image file from computer system 1000 (refer to the Pontiflex application). The request for the image file resource is constructed as an HTTP GET request with the key and value pairs in data object 901 added in as parameters of the HTTP GET request. The value of the key “dataTransfer_id” of the Offer object corresponding to the selected checkbox is also added as a parameter to the HTTP GET request. Finally, function submitAdSignup( ) closes and removes Ad Screen 2017.

If Application Secure Data Store 2015 does not contain data object 901, function submitAdSignup( ) creates a new array selectedOffers in application memory to store offers selected in Ad Screen 2017. Next, function submitAdSignup( ) executes the following for each checkbox in Ad Screen 2017. Function submitAdSignup( ) checks if the user selected the checkbox. If the checkbox was selected, the Offer object corresponding to the selected checkbox is added to selectedOffers array. Next, function submitAdSignup( ) invokes function showCompleteSignupForm( )) of AdManager 2014, next, function submitAdSignup( ) closes and removes Ad Screen 2017, and exits. In Operational Mode 1, since Ad Screen 2017 is immediately displayed after Registration Screen 2016, and Registration Screen 2016 ensures that Application Secure Data Store 2015 will contain data object 901, function submitAdSignup( )) does not have to go through the operations described in this paragraph in Operational Mode 2.

Operational Mode 2: Ad Screen Followed by “Complete Sign-Up” Screen

To effectuate an operational mode (Operational Mode 2) where an Ad Screen is displayed, followed by a “Complete Sign-up” Screen, the Developer creates a new instance of AdManager 2014 (refer to FIG. 27) by invoking the “new” method on AdManager 2014 in his/her Application Code. The Application Code then invokes the function showMultiOfferScreen( ) of AdManager 2014, typically immediately after the Application is launched.

In accordance with one or more embodiments of the present disclosure, function showMultiOfferScreen( ) calls Ad Optimizer 2003 of Ad Server computer system 2000 through its web interface (refer to FIG. 22) and passes: (a) the value of the key “dataSource_id” in Application Ad Configuration 2013 (refer to FIG. 26) as the id of the Data Source Configuration; (b) a list of keywords representing the Application content, if available; and (c) the value of the key “initNumOffers” in Application Ad Configuration 2013 (refer to FIG. 26) as the number of offers to fetch. In response, as described above, Ad Optimizer 2003 provides a list of Advertiser Offers in, for example and without limitation, JSON format, which list is received by function showMultiOfferScreen( ) Next, function showMultiOfferScreen( ) creates Ad Screen 2017 (refer to FIG. 28) that is fabricated in accordance with one or more embodiments of the present disclosure. For each Offer object in the list of Advertiser Offers received from Ad Optimizer 2003, showMultiOfferScreen( ) creates the “Offer Block” by creating a native text element and setting its value to the “header” value of the Offer object. Next, function showMultiOfferScreen( ) creates another native text element and sets its value to the “body” value of the Offer object. Next, function showMultiOfferScreen( ) creates a native checkbox element with the checkbox set to unselected state. Next, function showMutiOfferScreen( ) creates native button element “Button B1,” and sets the onclick event of Button B1 to invoke function submitAdSignup( ) of AdManager 2014. Next, function showMultiOfferScreen( ) creates another native button element, “Button B2,” and sets the onclick event of Button B2 to invoke function cancelAction( ) of AdManager 2014. If the user clicks on “Button B2,” Ad Screen 2017 invokes function cancelAction( ) of AdManager 2014. In response, function cancelAction( ) closes and removes Ad Screen 2017.

If the user selects one or more offers and clicks on “Button B1,” Ad Screen 2017 invokes function submitAdSignup( ) function of AdManager 2014. In response, function submitAdSignup( ) checks if Application Secure Data Store 2015 contains data object 901.

If Application Secure Data Store 2015 contains data object 901, then for each checkbox in Ad Screen 2017, function submitAdSignup( ) checks if the user selected that checkbox. If the checkbox was selected, function submitAdSignup( ) constructs and adds a request for an image file from computer system 1000 (refer to the Pontiflex application). The request for the image file resource is constructed as an HTTP GET request with the key and value pairs in data object 901 added in as parameters of the HTTP GET request. The value of the key “dataTransfer_id” of the Offer object corresponding to the selected checkbox is also added as a parameter to the HTTP GET request. Finally, function submitAdSignup( ) closes and removes Ad Screen 2017.

If Application Secure Data Store 2015 does not contain data object 901, function submitAdSignup( ) creates a new array selectedOffers in application memory to store offers selected in Ad Screen 2017. Next, function submitAdSignup( ) executes the following for each checkbox in Ad Screen 2017. Function submitAdSignup( ) checks if the user selected the checkbox. If the checkbox was selected, the Offer object corresponding to the selected checkbox is added to selectedOffers array. Next, function submitAdSignup( ) invokes function showCompleteSignupForm( ) of AdManager 2014, next, function showCompleteSignupForm( ) closes and removes Ad Screen 2017, and exits.

Next, function showCompleteSignupForm( ) draws Complete Signup Screen 2018 (refer to FIG. 28)—Complete Signup Screen 2018 is fabricated in accordance with one or more embodiments of the present disclosure using native screen elements provided by the Application Programming Environment in accordance with any one of a number of methods that are well known to those of ordinary skill in the art. In particular, function showCompleteSignupForm( ) reads Application Ad Configuration 2013 (refer to FIG. 26). Then, function showCompleteSignupForm( ) creates a native text element “Complete Signup Offer Header” and sets its value to the text “Complete your signup.” Next, function showCompleteSignupForm( )) creates a text element “Complete Signup Offer Body,” and sets its value to the text “Enter your information below to complete your signup.” Next, function showCompleteSignupForm( ) creates “Form C” shown in FIG. 28 by creating native input text boxes for each of the fields listed in “dataSourceFields” in Application Ad Configuration 2013. Next, function showCompleteSignupForm( ) creates “Button C1” shown in FIG. 28, and sets the onclick event for Button C1 to invoke function submitCompleteSignupForm( ) of AdManager 2014. Next, function showCompleteSignupForm( ) creates “Button C2” shown in FIG. 28, and sets the onclick event for Button C2 to invoke function cancelAction( ) of AdManager 2014. In accordance with one or more embodiments of the present disclosure, if a user clicks on “Button A2,” Complete Signup Screen 2018 invokes the function cancelAction( ) of AdManager 2014, and function cancelAction( ) close and removes Complete Signup Screen 2018.

In accordance with one or more embodiments of the present disclosure, if a user clicks on “Button C1,” Complete Signup Screen 2018 invokes function submitCompleteSignupForm( ) of AdManager 2014. In accordance with one or more such embodiments, function submitCompleteSignupForm( ) executes the following steps. Function submitCompleteSignupForm( ) executes function validateForm( )) of AdManager 2014 which executes the following steps. Function validateForm( ) checks whether the user has entered information for all input fields inside form “FormC”. In addition, if the input fields inside form “FormC” include an Email field, function validateForm( ) of Ad Manager 2014 verifies that the value conforms to a valid “Email” syntax. In further addition, if the Developer chooses to restrict users to be residents of a particular country, and the input fields inside form “FormC” include a Postal Code field (for example, Zip Code in the United States), function validateForm( ) of AdManager 2014 verifies that the value conforms to a valid “PostalCode” syntax for that country. An example of this would be to check whether the “PostalCode” value is a five (5) digit number if the country is the United States. If these checks do not pass, a native “alert” notification box is called with a message informing the user that he/she has to correct a corresponding input field, and the function validateForm( ) of AdManager 2014 returns “false.” If all checks pass, function validateForm( ) of AdManager 2014 returns “true.”

Next, function submitCompleteSignupForm( ) of AdManager 2014 checks the return value of function validateForm( ) of AdManager 2014. If the return value of function validateForm( ) of AdManager 2014 is “false,” function submitCompleteSignupForm( ) of AdManager 2014 exits. If the return value of function validateForm( ) of AdManager 2014 is “true,” the process continues with the following steps.

For each Offer object in selectedOffers array (created by submitAdSignup function when Application Secure Data Store 2015 does not contain data object 901), function submitCompleteSignupForm( ) constructs and adds a request for an image file from computer system 1000 (refer to the Pontiflex application). The request for the image file is constructed as an HTTP GET request with the key and value pairs in data object 901 added in as parameters of the HTTP GET request. In addition, the value of the key “dataTransfer_id” of the Offer object is also added as a parameter of the HTTP GET request. Next, function submitCompleteSignupForm( ) closes and removes Complete Signup Screen Screen 2018.

Embodiments of the present disclosure described above are exemplary. As such, many changes and modifications may be made to the description set forth above by those of ordinary skill in the art while remaining within the scope of the disclosure. As such, the scope of the disclosure should be determined with reference to the appended claims along with their full scope of equivalents.

### APPENDIX

The Pontiflex™ Data Transfer System

One or more embodiments of the present disclosure utilize a computer system that provides a data bridge connecting Publishers (a Publisher is also referred to herein as a “data source” and may include a computer system or a mobile device), for example and without limitation, online Publishers, to Advertisers (an Advertiser is also referred to herein as a “data consumer” and may include a computer system referred to as an Advertiser computer system or as an Advertiser), for example and without limitation, online Advertisers, to transfer data between them. In particular, in accordance with one or more such embodiments, the computer system mediates data transfers so that data sources can connect to the computer system (i.e., the data bridge system) in their preferred data transfer protocols to send data, and data consumers can build their connections to the computer system (i.e., the data bridge system) in their preferred data transfer protocols to receive the data. As such, in accordance with one or more such embodiments, by converting data received from data sources into data sent to data consumers, the computer system (i.e., the data bridge system) can provide: (a) a flexible data bridge that enables simple connectivity between parties; (b) immediate delivery of customer data and lowered cost of doing business; and (c) greater value for data being transferred. As will be described below, the computer system integrates online data transfers (typically comprised of data provided by customers such as, for example and without limitation, name, email address, zip code, credit card number, or other information) between Publishers and Advertisers using a set up process. Once the set up process is complete, the computer system (i.e., the data bridge system) can translate data received from a Publisher (i.e., a data source or Publisher computer system) and send the data to an Advertiser (i.e., a data consumer or Advertiser computer system) by automatically recognizing the data output format provided by the Publisher and converting that information into the data input format required by the Advertiser. In addition, the computer system (i.e., the data bridge system) can archive the data for backup purposes, and all transfer statistics and metrics can be viewed by consumers via a web interface. In accordance with one or more such embodiments, the computer system (i.e., the data bridge system) and its method of operation can enable (and advantageously can simplify) data transfer between data sources and data consumers via, for example and without limitation, open data transfer protocols. In accordance with one or more such embodiments, the data transferred may be in the form of a data structure, for example and without limitation, a data structure in tabular form consisting of one or more rows, with each row consisting of one or more columns (fields). In accordance with one or more such embodiments, the computer system (i.e., the data bridge system) can automatically guess and map each Advertiser data field to a Publisher data field using string matching algorithms to compare and match data field names. Advantageously, this enables Publishers and Advertisers to skip an intermediate step of manually matching and connecting Advertiser and Publisher lists of fields, and reduces the number of steps to set up a data transfer in the computer system (i.e., the data bridge system). In accordance with one or embodiments, the computer system (i.e., the data bridge system) and its described method of operation can provide the following capabilities: (a) a web-enabled interface (for example and without limitation, a form) for use by consumers to sign up for services rendered by the computer system (i.e., the data bridge system); (b) a web-enabled interface (for example and without limitation, a form) to set up data source configurations that specify (i) data transfer protocols used to transfer data from a data source to the computer system (i.e., the data bridge system), and (ii) data fields that make up each record of data received from the data source; (c) a web-enabled interface (for example and without limitation, a form) to set up data consumer configurations that specify (i) data transfer protocols used to transfer data from the computer system (i.e., the data bridge system) to a data consumer, and (ii) data transfer fields that make up each record of data to be sent to the data consumer; and (d) a web-enabled interface (for example and without limitation, a form) to set up data transfer configurations that specify (i) whether the computer system (i.e., the data bridge system) will pull data from a data source or the data source will push data to the computer system (i.e., the data bridge system), (ii) where the data source will push data to the computer system (i.e., the data bridge system), the computer system (i.e., the data bridge system) will create a data storage area for the data transfer, and, if required by the data transfer protocol (specified in the data source configuration), will generate credentials to access the data storage area, (iii) where the computer system (i.e., the data bridge system) will pull data from the data source, the data store information and credentials required by the computer system (i.e., the data bridge system) to access a data store created by the data source, (iv) whether the computer system (i.e., the data bridge system) will push data to a data consumer or the data consumer will pull the data from computer system (i.e., the data bridge system), (v) where the data consumer will pull data from the computer system (i.e., the data bridge system), the computer system (i.e., the data bridge system) will create a data storage area for the data transfer, and if required by the data transfer protocol (as specified in data consumer configuration), generate credentials to access the data storage area, (vi) where the computer system (i.e., the data bridge system) will push data to the data consumer, the data store information and credentials required by the computer system (i.e., the data bridge system) to access the data storage area created by the data consumer, and (vii) the computer system (i.e., the data bridge system) will automatically match the list data fields to be sent to the data consumer to the list of data fields received from the data source and will provide a web-based form to have the consumer verify and manually correct any mismatches between the two sets of data fields. In particular, one embodiment is a data bridge between Publishers and Advertisers for sending data from a Publisher to an Advertiser, which data bridge comprises: a computer system, which computer system includes: (a) a data consumer configurator; (b) a data source configurator; (c) a configuration data store; (d) a data transfer configurator; (e) a data transfer scheduler; (f) a data transfer engine; (g) a primary data store; (h) a tracking and billing component; and (i) an archiver.

FIG. 1 is a block diagram of a system architecture of computer system 1000. As shown in FIG. 1, computer system 1000 comprises data consumer (or Advertiser export) configurator 100, data source (or Publisher import) configurator 200, configuration data store 250, data transfer configurator 300, data transfer scheduler 400, data transfer engine 500, primary (or main lead) data store 600, tracking and billing component 700, and archiver 800. As one of ordinary skill in the art can readily appreciate, data consumer configurator 100, data source configurator 200, configuration data store 250, data transfer configurator 300, data transfer scheduler 400, data transfer engine 500, primary data store 600, tracking and billing component 700, and archiver 800 are combinations of software modules and computer hardware that provide functionality that will be described in detail below. In particular, computer system 1000 may include one or more computers, each of which includes computer hardware such as, for example and without limitation, one or more CPUs, computer memory (for example random access memory), data stores in the form of computer disks unit(s) and/or solid state storage, Internet interface equipment, communications interfaces, user interfaces such as user monitors and CRT displays or flat panel displays or touch screen displays and so forth, user input devices such as keyboards, and so forth. As one of ordinary skill in the art can readily appreciate, data consumer configurator 100, data source configurator 200, configuration data store 250, data transfer configurator 300, data transfer scheduler 400, data transfer engine 500, primary data store 600, tracking and billing component 700, and archiver 800 may comprise software modules executing on the same computer or may comprise software modules executing on one or more different computers, and the data stores may utilize storage hardware associated with the same computer or one or more different computers. Certain parts of the description below refer to a data source and a data consumer having web access to computer system 1000. In accordance with one or more embodiments, this is done by a data source and a data consumer first going to a website of a company (for example, Pontiflex, Inc.) running computer system 1000 and registering for an account. Registration may be done, for example and without limitation, by providing registration credentials such as, for example and without limitation, a name, email address, mailing address, and perhaps other contact information. The registration credentials are reviewed by the company (for example, Pontiflex, Inc.) staff, and, provided they are judged to be valid in accordance with company criteria, the company staff creates an account for the consumer and sends login credentials (for example, consumer ID and password) to the consumer via email or telephone. Consumers then can go to the company's website and click a “Log In” button and use these credentials to log in to computer system 1000. In accordance with one or more further embodiments, consumers can create their own accounts without prior approval by company staff. In accordance with one or more such embodiments, upon submitting their credentials, computer system 1000 automatically creates and presents a password and consumer name for the registrant after they register. However, in either case, company staff have an option to disable a consumer account of consumer immediately via computer system 1000.

Data Consumer Section

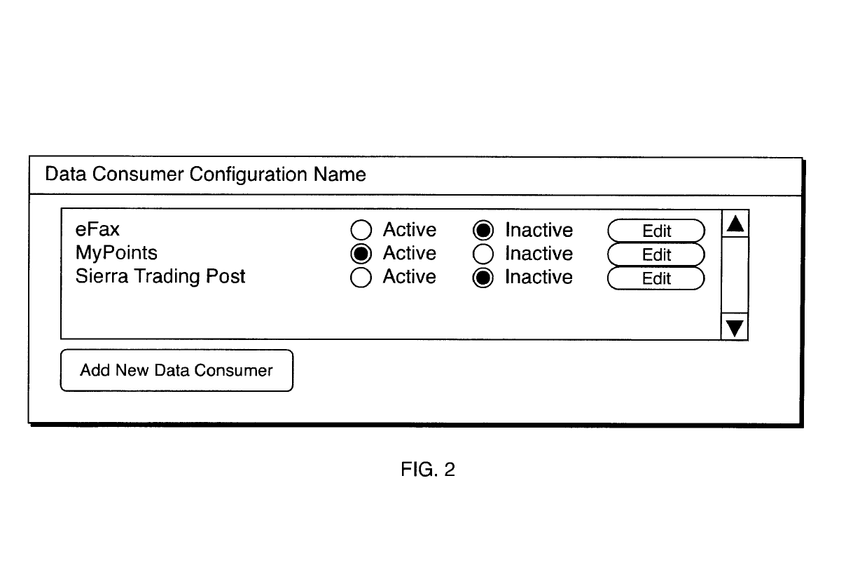

FIGS. 2-4 show screens used to describe data consumer configurator 100 that is fabricated in accordance with one or more embodiments to help one of ordinary skill in the art understand how to make and use computer system 1000. In accordance with one or more embodiments, data consumer configurator 100 is a module of computer system 1000 that exposes an interface, for example and without limitation, a web interface, in accordance with any one of a number of methods that are well known to those of ordinary skill in the art, wherein a data consumer can specify parameters required to receive data from computer system 1000. In accordance with one or more embodiments, the data consumer uses the interface as a set up tool, for example and without limitation, as a one-time set up tool, to specify configuration data (also referred to herein as a “configuration”) relating, among other things, to how computer system 1000 will send data to the data consumer. In accordance with one or more embodiments, the data consumer will need to change its configuration data only if it makes changes, for example and without limitation, in the way it wants or needs to receive data from computer system 1000. In addition, in accordance with one or more embodiments, a data consumer, if it chooses, can specify multiple configurations, for example and without limitation, one configuration for each different method of receiving data from computer system 1000. As will be described in detail below, the interface will provide web pages: (a) listing all existing configurations; (b) listing options to edit existing configurations; and (c) enabling addition of new configurations.

For a data consumer to initiate a new data consumer configuration or to edit an existing one, the data consumer accesses a web interface exposed by data consumer configurator 100 by clicking on a link to the web interface in a browser. In response, data consumer configurator 100 queries configuration data store 250 to retrieve all existing data consumer configurations set up by the data consumer previously (in accordance with any one of a number of methods that are well known to those of ordinary skill in the art), and data consumer configurator 100 displays this data as a list in the screen shown in FIG. 2 (in accordance with any one of a number of methods that are well known to those of ordinary skill in the art). As shown in the screen shown in FIG. 2, and in accordance with one or more embodiments, each data consumer configuration has a name, and a flag (“Active” or “Inactive”) used to indicate to data transfer engine 500 that the data consumer will accept data according to the format and method specified by this data consumer configuration. In addition, as shown in the screen shown in FIG. 2, an “Edit” button is displayed next to each data consumer configuration (in accordance with any one of a number of methods that are well known to those of ordinary skill in the art) to allow the data consumer to edit the data consumer configuration. In addition, an “Add New Data Consumer” button is displayed to enable the data consumer to create a new data consumer configuration.

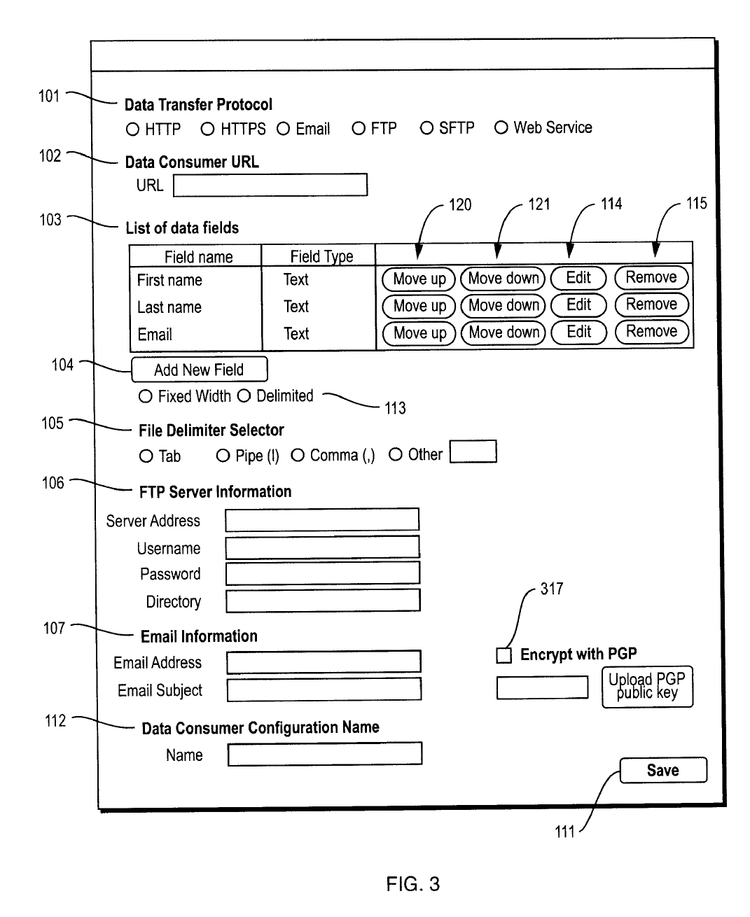

In response to the data consumer's clicking the “Edit” button on the screen shown in FIG. 2, in accordance with one or more embodiments, data consumer configurator 100 presents the screen shown in FIG. 3, pre-populated with the selected data consumer configuration information (in accordance with any one of a number of methods that are well known to those of ordinary skill in the art). In response to the data consumer's clicking the “Add New Data Consumer” button on the screen shown in FIG. 2, in accordance with one or more embodiments, data consumer configurator 100 presents the screen shown in FIG. 3 (in accordance with any one of a number of methods that are well known to those of ordinary skill in the art). FIG. 3 illustrates an instance of a data consumer configuration with Data Transfer Protocol selector 101, Data Consumer URL form 102, List of data fields 103, “Add New Field” button 104, File Delimiter Selector 105, optional FTP Server Information form 106, optional Email Information form 107, and Data Consumer Configuration Name 112. Based on consumer selection from Data Transfer Protocol selector 101, data consumer configurator 100 will conditionally display Data Consumer URL form 102, File Delimiter Selector 105, FTP Server Information form 106, or Email Information form 107. For example, if the consumer selects HTTP or HTTPS from Data Transfer Protocol selector 101, Data Consumer URL form 102 is displayed and File Delimiter Selector 105, FTP Server Information form 106, and Email Information form 107 are not displayed. However, if the consumer selects FTP or SFTP from Data Transfer selector 101, then File Delimiter Selector 105 and FTP Server Information form 106 are displayed, and Data Consumer URL form 102 and Email Information form 107 are not displayed. Lastly, if the consumer selects Email from Data Transfer Selector 101, then File Delimiter Selector 105 and Email Information form 107 are displayed, and Data Consumer URL form 102 and FTP Server Information form 106 are not displayed.

Data Transfer Protocol selector 101 specifies the data transfer protocol that must be used for the data consumer to accept data from computer system 1000. In accordance with one or more embodiments, data consumer configurator 100 displays a list of data transfer protocols (for example and without limitation, FTP, RCP, SFTP, SCP, HTTP, HTTPS, and SOAP via Web Service) from which the data consumer may choose. Data Consumer URL form 102 is the data consumer's web URL which computer system 1000 will use to transfer data to the data consumer if the data consumer selects to transfer data using HTTP or HTTPS POST. List of data fields 103 specifies the data fields that make up a single data record of the data transfer to the data consumer. In accordance with one or more embodiments, on the screen shown in FIG. 3, the data consumer will specify: (a) in case the consumer selects FTP or Email for data transfer protocol, the required ordering of data fields (as shown in the screen shown in FIG. 3) within each row of data (in accordance with one or more embodiments, the data consumer specifies the ordering of data fields by clicking on “Move up” button 120 or “Move down” button 121): (b) data fields to be removed from list of data fields 103 by clicking on “Remove” button 115; and (c) whether to have data fields in fixed-width format or to have data fields be delimited by a chosen character using selector 113. If the data consumer chooses to use delimited data fields by selecting a “Delimited” option for selector 113 on the screen shown in FIG. 3, the data consumer will specify a delimiter character using File Delimiter Selector 105. File Delimiter Selector 105 specifies the delimiter character that will be used to separate the data fields. File Delimiter Selector 105 will be shown only if the data consumer elects to transfer data using FTP or SFTP or email data transfer protocols. The delimiter character can be, for example and without limitation, comma(,), tab(\t), pipe(I), or any other single character of the data consumer's choice (in accordance with any one of a number of methods that are well known to those of ordinary skill in the art).

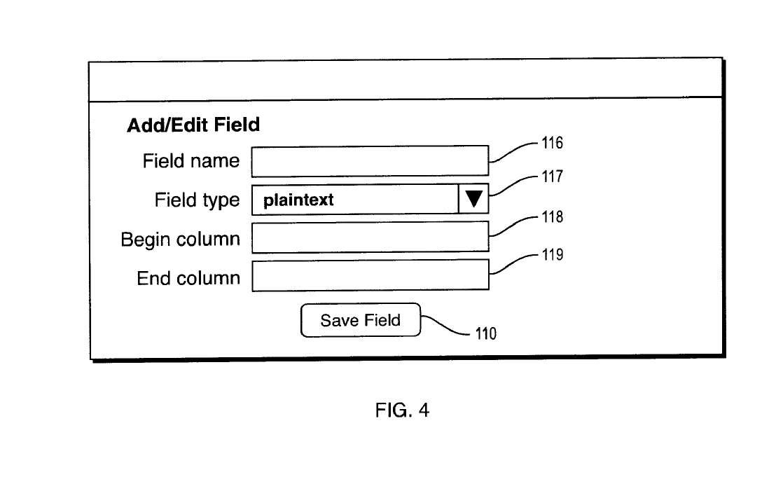

FTP Server Information form 106 includes the FTP server address, FTP server consumername and password, and FTP directory name that will be used by computer system 1000 to transfer data to the data consumer if the data consumer elects to transfer data using FTP or SFTP. Email Information form 107 includes the email addresses and email subject that will be used by computer system 1000 to transfer data to the data consumer if the data consumer elects to transfer data using Email. If the data consumer clicks on “Add New Field” button 104, data consumer configurator 100 will display the screen shown in FIG. 4.

To use the screen shown in FIG. 4, the data consumer will enter a field name in Field name 116, and select a field type using Field type 117. If the data consumer chooses to use a fixed width format by selecting a “Fixed width” option from selector 113 on the screen shown in FIG. 3, data consumer configurator 100 will present a begin column number in Begin column 118 and an end column number in End column 119 for the new field on the screen shown in FIG. 4. The data consumer selects a field type from an existing list of field types in Field type 117 to identify the format of the data field to computer system 1000, examples of field types include text, number, date, phone number, country code, state, zip. After the data consumer clicks “Save field” button 110 on the screen shown in FIG. 4, the data consumer configurator 100 adds the field name to the data consumer configuration, and the new field is displayed on list of fields 103 on the screen shown in FIG. 3. If the data consumer clicks on “Edit” button 114 on the screen shown in FIG. 3, data consumer configurator 100 displays the screen shown in FIG. 4 pre-populated with the selected field name in Field name 116, and a field type in Field type 117. In addition, if the data consumer selects the “Fixed Width” option from selector 113 on the screen shown in FIG. 3, data consumer configurator 100 displays a begin column number in Begin column 118 and an end column number in End column 119 on the screen shown in FIG. 4. After the data consumer clicks on “Save Field” button 110 on the screen shown in FIG. 4, the data consumer configurator 100 stores the changes to the field, and the changes are reflected in List of data fields 103 on the screen shown in FIG. 3. In accordance with one or more embodiments of, the data consumer can choose to receive files securely by having computer system 1000 send files encrypted using the data consumer's PGP key. To do this, the data consumer will select “Encrypt with PGP” checkbox 317 on the screen shown in FIG. 3, and enter an address of a file containing the PGP public key or browse its own system (in accordance with any one of a number of methods that are well known to those of ordinary skill in the art) to find the PGP public key file. In response, data consumer configurator 100 will upload the data consumer's PGP public key, and store it in configuration data store 250. Later, computer system 1000 will use the data consumer's PGP public key to encrypt files to be transferred to the data consumer.

The data consumer enters a human-readable name in Data Consumer Configuration Name form 112 to identify the data consumer configuration in data consumer configurator 100. After entering the required information on the screen shown in FIG. 3, the data consumer clicks on “Save” button 111 to save the data consumer configuration to configuration data store 250.

In accordance with one or more embodiments, data consumer configurator 100 stores the data consumer configuration in machine-readable format (for example and without limitation, in XML or as normalized database tables) in configuration data store 250 (in accordance with any one of a number of methods that are well known to those of ordinary skill in the art). The data components comprising the data consumer configuration are set forth in detail in FIG. 13.

Data Source Section

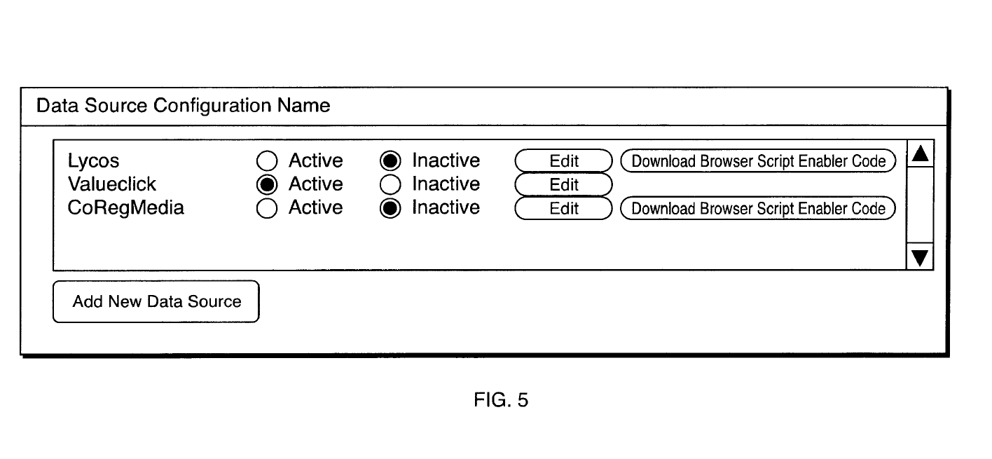

For a data source to initiate a new data source configuration or to edit an existing one, the data source accesses a web interface exposed by data source configurator 200 by clicking on a link to the web interface in a browser. In response, data source configurator 200 queries configuration data store 250 to retrieve all existing data source configurations set up by the data source previously (in accordance with any one of a number of methods that are well known to those of ordinary skill in the art), and data source configurator 200 displays this data as a list in the screen shown in FIG. 5 (in accordance with any one of a number of methods that are well known to those of ordinary skill in the art). As shown in the screen shown in FIG. 5, and in accordance with one or more embodiments, each data source configuration has a name, and a flag (“Active” or “Inactive”) used to indicate to data transfer engine 500 that the data source will send data according to the format and method specified by this data source configuration. In addition, as shown in the screen shown in FIG. 5, an “Edit” button is displayed next to each data source configuration (in accordance with any one of a number of methods that are well known to those of ordinary skill in the art) to allow the data source to edit the data source configuration. In addition, an “Add New Data Source” button is displayed to enable the data source to create a new data source configuration.

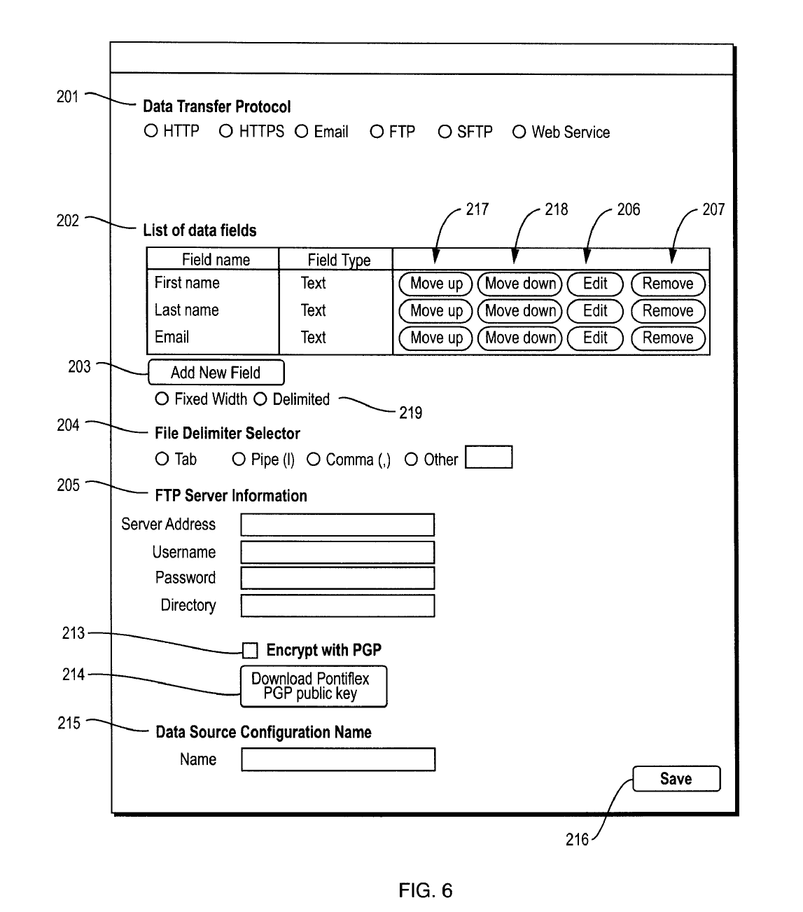

In response to the data source's clicking the “Edit” button on the screen shown in FIG. 5, in accordance with one or more embodiments, data source configurator 200 presents the screen shown in FIG. 6, pre-populated with the selected data source configuration information (in accordance with any one of a number of methods that are well known to those of ordinary skill in the art). In response to the data source's clicking the “Add New Data Source” button on screen shown in FIG. 5, in accordance with one or more embodiments, data source configurator 200 presents the screen shown in FIG. 6 (in accordance with any one of a number of methods that are well known to those of ordinary skill in the art). FIG. 6 illustrates an instance of a data source configuration with Data Transfer Protocol selector 201, List of data fields 202, “Add New Field” selector 203, File Delimiter Selector 204, optional FTP Server Information form 205, and Data Source Configuration Name form 206. Based on data source selection from Data Transfer Protocol selector 201, data source configurator 200 will conditionally display File Delimiter Selector 204 or FTP Server Information form 205. For example, if the data source selects HTTP or HTTPS from Data Transfer Protocol selector 201, File Delimiter Selector 204 and FTP Server Information form 205 are not displayed. However, if the data source selects FTP or SFTP from Data Transfer Protocol Selector 201, then File Delimiter Selector 204 and FTP Server Information form 205 are displayed.

Data Transfer Protocol selector 201 specifies the data transfer protocol that the data source will use to send data to computer system 1000. In accordance with one or more embodiments, data source configurator 200 displays a list of data transfer protocols (for example and without limitation, FTP, RCP, SFTP, SCP, HTTP, HTTPS, and SOAP via Web Service) from which the data source may choose. List of data fields 203 specifies the data fields that make up a single data record of the data transfer from the data source. In accordance with one or more embodiments, on the screen shown in FIG. 6, the data source will specify: (a) in case the data source selects FTP or Email for data transfer protocol, the required ordering of data fields (as shown in the screen shown in FIG. 6) within each row of data (in accordance with one or more embodiments, the data source specifies the ordering of data fields by clicking on “Move up” button 217 or “Move down” button 218); (b) data fields to be removed from List of data fields 202 by clicking on “Remove” button 207; and (c) whether to have data fields in fixed-width format or to have data fields be delimited by a chosen character using selector 219. If the data source chooses to use delimited data fields by selecting a “Delimited” option for selector 219 on the screen shown in FIG. 6, the data source will specify a delimiter character using File Delimiter Selector 204. File Delimiter Selector 204 specifies the delimiter character that will be used to separate the data fields. File Delimiter Selector 204 will be shown only if the data source elects to transfer data using FTP or SFTP or email data transfer protocols. The delimiter character can be, for example and without limitation, comma(,), tab(\t), pipe(I), or any other single character of its choice (in accordance with any one of a number of methods that are well known to those of ordinary skill in the art).

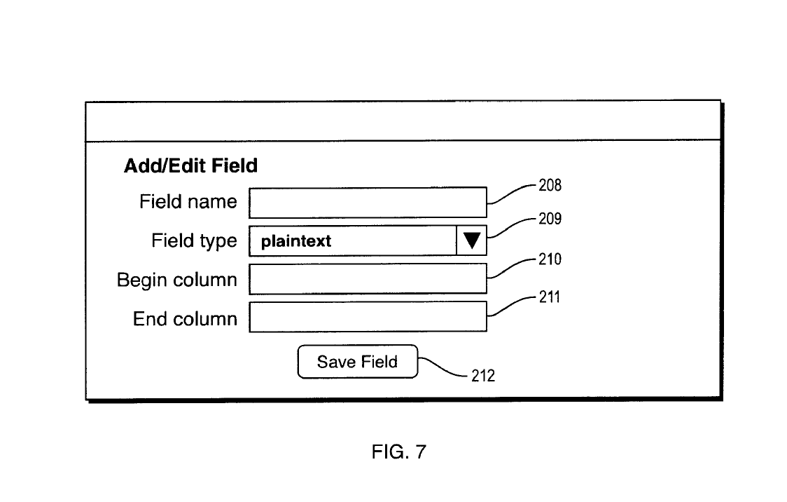

FTP Server Information form 205 includes the FTP server address, the FTP server data sourcename and password, and the FTP directory name that will be used by computer system 1000 to receive data from the data source if the data source elects to transfer data using FTP or SFTP. If the data source clicks on “Add New Field” button 203, data source configurator 200 displays the screen shown in FIG. 7.

To use the screen shown in FIG. 7, the data source will enter the field name Field name 208, and select a field type using Field type 209. If the data source chooses to use a fixed width format by selecting a “Fixed width” option from selector 219 on the screen shown in FIG. 6, data source configurator 200 will present a begin column number in Begin column 210 and an end column number in End column 211 for the new field on the screen shown in FIG. 7. After the data source clicks “Save field” button 212 on the screen shown in FIG. 7, data source configurator 200 adds the field name to the data source configuration, and the new field is displayed on List of data fields 202. If the data source clicks on “Edit” button 206 on the screen shown in FIG. 6, data source configurator 200 displays the screen shown in FIG. 7 pre-populated with the selected field name in Field name 208 and a field type in Field type 209. In addition, if the data source selects the “Fixed Width” option from selector 219 on the screen shown in FIG. 6, data source configurator 200 displays a begin column number in Begin column 210 and an end column number in End column 211 on the screen shown in FIG. 7. After the data source clicks on “Save field” button 212 on the screen shown in FIG. 7, data source configurator 200 stores the changes to the field, and the changes are reflected in List of data fields 202 on the screen shown in FIG. 6. In accordance with one or more embodiments, the data source can choose to send files securely by encrypting files with computer system 1000's public PGP key. To do this, the data source will click “Encrypt with PGP” checkbox 213 on the screen shown in FIG. 6, and click on “Download Pontiflex PGP public key” button 214. In response, the data source will download computer system 1000's public PGP key. In accordance with one or more embodiments, computer system 1000 will decrypt files sent by the data source using computer system 1000's PGP private key.

The data source enters a human-readable name in Data Source Configuration Name form 215 to identify the data source configuration in data source configurator 200. After entering the required information on the screen shown in FIG. 6, the data source clicks on “Save” button 216 to save the data source configuration to configuration data store 250.

In accordance with one or more embodiments, data source configurator 200 stores the data source configuration in machine-readable format (for example and without limitation, in XML or as normalized database tables) in configuration data store 250 (in accordance with any one of a number of methods that are well known to those of ordinary skill in the art). The data components comprising the data source configuration are set forth in detail in FIG. 12.

Data Transfer Section

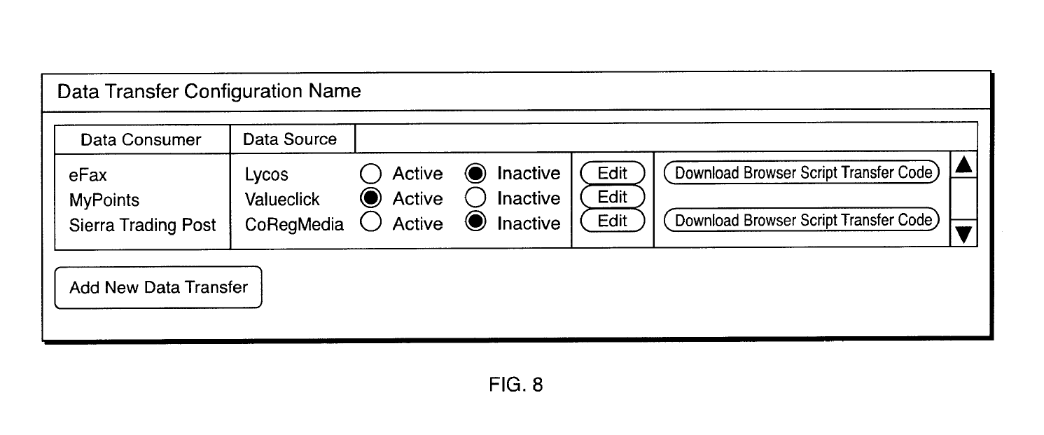

In accordance with one or more embodiments, data transfer configurator 300 is a module of computer system 1000 that exposes an interface, for example and without limitation, a web interface, wherein a user can set up a data transfer from a data source to a data consumer using a pre-existing data source configuration and data consumer configuration from configuration data store 250. In accordance with one or more embodiments, users will use this interface as a set up (for example, one-time set up) tool for each data transfer. A data transfer configuration will need to change only if the data source or the data consumer changes its respective configuration. In accordance with one or more embodiments, an interface (refer to FIG. 8) will display web pages where a user can view its current data transfer configurations, edit these data transfer configurations, and/or add new data transfer configurations.

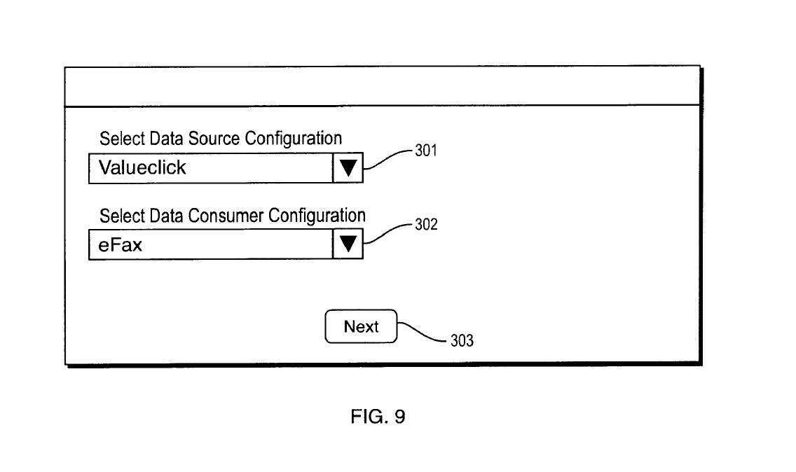

For a user to initiate a new data transfer configuration or to edit an existing one, the user accesses a web interface exposed by data transfer configurator 300 by clicking on a link to the web interface in a browser. In accordance with one or more embodiments, upon a user's initiating a new data transfer configuration, or editing an existing data transfer configuration, data transfer configurator 300 will present web forms requesting information. In accordance with one or more embodiments, first, data transfer configurator 300 displays a screen (refer to FIG. 9). The user selects a data source configuration from a “Select Data Source Configuration” list and selects a data consumer configuration from a “Select Data Consumer Configuration” list. Data transfer configurator 300 creates the “Select Data Source Configuration” list by listing all data source configurations in configuration data store 250 (in accordance with any one of a number of methods that are well known to those of ordinary skill the art). Data transfer configurator 300 creates the “Select Data Consumer Configuration” list by listing all data consumer configurations in configuration data store 250 (in accordance with any one of a number of methods that are well known to those of ordinary skill the art). After selecting a data source configuration and a data consumer configuration, the user clicks on a “Next” button on the screen.

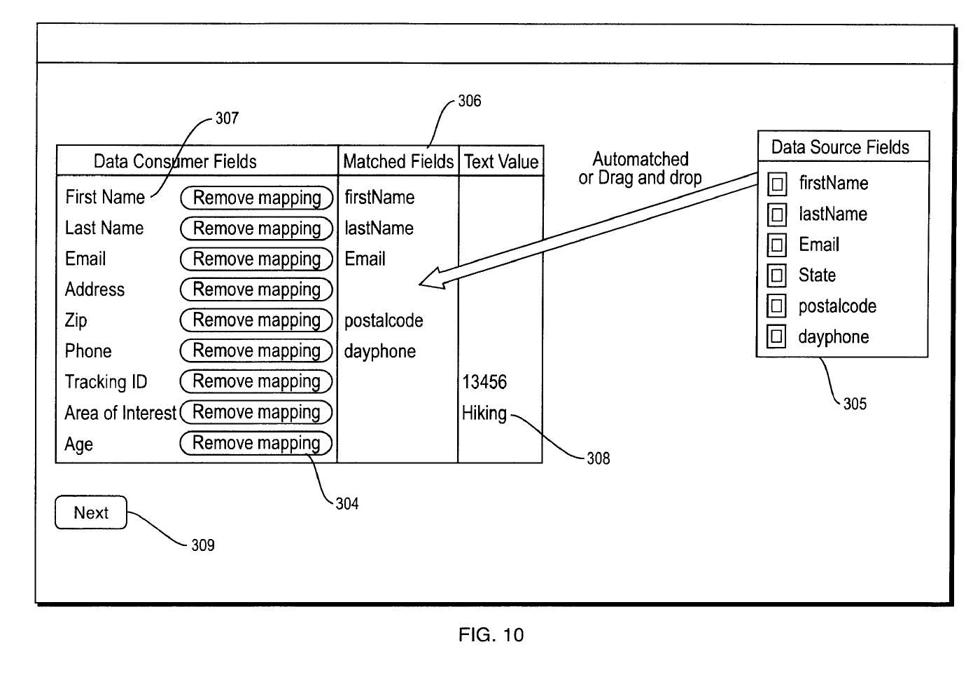

In accordance with one or more embodiments, whenever the user clicks on the “Next” button on the screen, data transfer configurator 300 will map each data field defined in the data consumer configuration selected on the screen to data fields defined in the data source configuration selected in the screen. Data transfer configurator 300 maps a data consumer field to a data source field by selecting the data source field name which best matches the data consumer field name using, for example and without limitation, established and existing implementations of approximate string matching algorithms (in accordance with any one of a number of methods that are well known to those of ordinary skill the art such as, for example and without limitation, those referenced at http://en.wikipedia.org/wiki/Approximate string matching and http://en.wikipedia.org/wiki/agrep, nrgrep, cgrep. After mapping data consumer fields to data source fields, the data transfer configurator 300 displays a screen (refer to FIG. 10) where the user can verify these mappings and modify them if required.

In accordance with one or more embodiments, data transfer engine 500 uses mappings defined on the screen to map data sent by the data source to data sent to the data consumer. In particular, it does this by using a value in the data source field and populating that value in a corresponding data consumer field. In the case where the data consumer field is mapped to a fixed text value instead of a data source field, the fixed text value is used to populate the data consumer field.

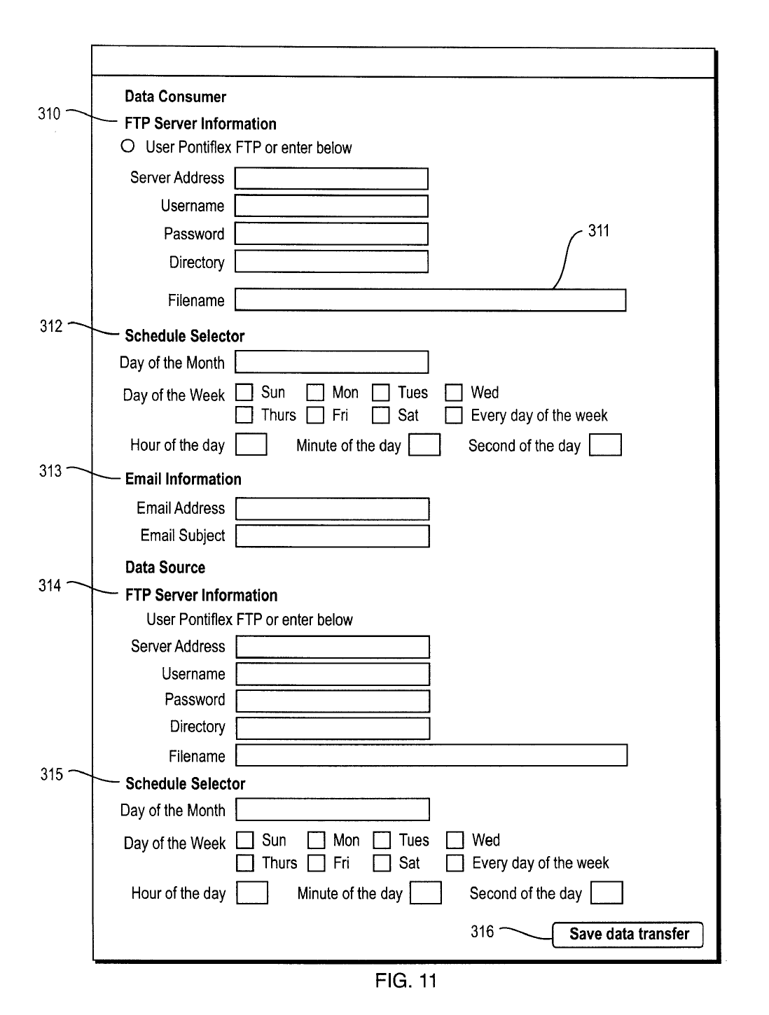

After the user clicks a “Next” button, data transfer configurator 300 presents another screen (refer to FIG. 11). If the data transfer protocol for the selected data consumer from “Select Data Consumer Configuration” list 302 is set up as FTP or SFTP, data transfer configurator 300 will show an FTP Server Information form—the values for the FTP Server Information form will be pre-populated from FTP Server Information from the data consumer configuration. In accordance with one or more such embodiments, the user can override this information by entering a different FTP server address, username, password and/or directory in the FTP Server Information shown on the screen. In addition, the user can also override this information by selecting to use an FTP server provided by computer system 1000. In this case, computer system 1000 will create an FTP username, password and directory in primary data store 600. If the data transfer protocol for the selected data consumer from “Select Data Consumer Configuration” list 302 is set up as FTP or SFTP or Email, data transfer configurator 300 will show a Filename form on the screen. Data transfer engine 500 will use the filename entered in this field to name the files used for the data transfers sent to the data consumer.

If the data transfer protocol for the selected data consumer from “Select Data Consumer Configuration” list 302 is set up as FTP or SFTP or Email, data transfer configurator 300 will show Schedule Selector form 312 wherein the user can specify a schedule in the form of day of month, day of week, and hour/minute/second of day. Data transfer configurator 300 will use the values entered in Schedule Selector form 312 to set up a transfer schedule in data transfer scheduler 400. Data transfer scheduler 400 will send the data transfer to the data consumer using data transfer engine 500 according to the specified schedule. If the data transfer protocol for the selected data consumer from “Select Data Consumer Configuration” list 302 is set up as Email, data transfer configurator 300 will show an Email Information form on the screen. The values for the Email Information form will be pre-populated with email information from the data consumer configuration. The user can override this information by entering a different email address and email subject in the Email Information form on the screen.

If the data transfer protocol for the selected data source from “Select Data Source Configuration” list 301 is set up as FTP or SFTP, data transfer configurator 300 will show an FTP Server Information form on the screen. The values for the FTP Server Information form will be pre-populated from FTP Server Information from the data source configuration. In accordance with one or more such embodiments, the user can override this information by entering a different FTP server address, username, password and/or directory in the FTP Server Information form shown on the screen. In addition, the user can also override this information by selecting to use an FTP server provided by computer system 1000. In this case, computer system 1000 will create an FTP username, password and directory in primary data store 600. If the data transfer protocol for the selected data source from “Select Data Source Configuration” list 301 is set up as FTP or SFTP, data transfer configurator 300 will show Schedule Selector form 315 wherein the user can specify a schedule in the form of day of month, day of week, and hour/minute/second of day. Data transfer scheduler 400 will pull data from the data source using data transfer engine 500 according to the specified schedule. Next, the user clicks a “Save data transfer” button and data transfer configurator 300 saves the data transfer configuration in configuration data store 250.

Finally, in accordance with one or more embodiments, data transfer configurator 300 stores the configuration in machine-readable format (for example and without limitation, in xml or as normalized database tables) in configuration data store 250 (in accordance with any one of a number of methods that are well known to those of ordinary skill in the art). The data components comprising the data transfer configuration is detailed in FIG. 14.

In accordance with one or more embodiments, data transfer scheduler 400 is a module of computer system 1000 that is used in the manner described below for data transfers that are set up to use an FTP, an SFTP or an Email data transfer protocol. According to the schedule specified during data transfer configuration, data transfer scheduler 400 will send data to a data consumer or pull data from a data source.

Data transfer scheduler 400 uses established and pre-existing implementations of job scheduling algorithms such as, for example and without limitation, Unix crontab or jcrontab.

Data transfer engine 500 handles the actual transfer of data from a data source to a data consumer (in accordance with any one of a number of methods that are well known to those of ordinary skill in the art). For a data transfer, a data transfer engine retrieves a data source configuration, a data transfer configuration, and a data consumer configuration from configuration data store 250. Data transfer engine 500 receives data from the data source, transforms the received data into a form required by the data consumer as specified in the data consumer configuration and data transfer configuration, and sends the transformed data to the data consumer. In accordance with one or more embodiments, a data transfer engine is capable of communicating in an open protocol such as, for example and without limitation, FTP, SFTP, RCP, SCP, HTTP, HTTPS, and SOAP.

In accordance with one or more embodiments, primary data store 600 is a module of computer system 1000 that is used when a data source or a data consumer chooses to send data to or receive data from, respectively, computer system 1000 using FTP, SFTP or Email data transfer protocols. In accordance with one or more embodiments, primary data store 600 comprises multiple data stores that are load-balanced (in accordance with any one of a number of methods that are well known to those of ordinary skill in the art). In accordance with one or more embodiments, the data stores of primary data store 600 expose one or more of an FTP, an SFTP, an SCP, an HTTP, an HTTPS, an SMTP, and a Web Service interface (in accordance with any one of a number of methods that are well known to those of ordinary skill in the art). In accordance with one or more embodiments, the interfaces will be exposed by using open source or third party proprietary software such as, for example and without limitation, proftpd (FTP), Apache web server (HTTP, HTTPS), and so forth. In addition, and in accordance with one or more embodiments, all of the data stores of primary data store 600 share a common authentication module for example and without limitation, openldap (LDAP) that is fabricated in accordance with any one of a number of methods that are well known to those of ordinary skill in the art. Advantageously, this enables the same authentication token to be used across multiple data stores in accordance with any one of a number of methods that are well known to those of ordinary skill in the art.

Further, in accordance with one or more embodiments, primary data store 600 can create separate, secure data areas for each data source and data consumer, and can auto-generate credentials in a common authentication module to access these data areas (in accordance with any one of a number of methods that are well known to those of ordinary skill in the art). The credentials are auto-generated during the data transfer configuration process if the user selects to use computer system 1000's FTP server for data transfer.

In accordance with one or more embodiments, where a data source chooses to send data to computer system 1000 via an HTTP or HTTPS data transfer protocol, the data source has an option to send the data to computer system 1000 using a BrowserScriptPost code snippet that will be generated by computer system 1000, and will be available to download by the data source via a computer system 1000-provided web interface (alternatively, computer system 1000 may provide the BrowserScriptPost code snippet by email or a user of computer system 1000 may cause the BrowserScriptPost code snippet to be downloaded). The BrowserScriptPost code snippet provides a mechanism for sending data records directly to computer system 1000, in real time, without the data source's having to write custom backend code. In essence, as will be described below, set up for this functionality involves inserting a few lines of, for example and without limitation, JavaScript into, for example and without limitation, the Success or Thank You page at the end of a deal process flow.

In accordance with one or more embodiments, a BrowserScriptPost code snippet is provided to a data source in a browser based scripting language. For example, where the data source is collecting data via HTML web forms, the BrowserScriptPost code snippet may be provided as a JavaScript code snippet. The data source will insert the BrowserScriptPost code snippet into its HTML web form so that it may be used after the data it is sending to computer system 1000 has been collected by the data source, for example, after a user registration or order form step has been completed. FIG. 15 shows an HTML source code view of a sample data source-owned HTML web page that includes a BrowserScriptPost code snippet that is fabricated in accordance with one or more embodiments. As shown in FIG. 15, the BrowserScriptPost code snippet comprises three components: (a) a first component, data object 901, is an object that contains data to be transferred to computer system 1000 that can be accessed by the browser scripting language; (b) a second component, component 902, is a function that converts data object 901 to a request for an image resource from computer system 1000; and (c) a third component, component 903, is a call to the function defined in component 902 that passes data object 901 as a parameter, thereby effectively sending data collected by the data source in data object 901 to computer system 1000 as part of the image request.

In accordance with one or more embodiments, where the BrowserScriptPost code snippet is provided as a JavaScript code snippet, data object 901 is a JavaScript object which is a collection of properties of key name and value pairs such as, for example and without limitation, data=(name:“name_value”, email:“email_value”, zip:“zip_value”). This JavaScript object is generated for the data source by computer system 1000 by populating the key names as the names of the fields defined by the data source in data source configurator 200 in List of data fields 202 on the screen shown in FIG. 6. The values for the keys will be the data collected by the data source that it wants to send to the data consumer via computer system 1000. The values will be populated by the data source in the JavaScript object using any technology such as, for example and without limitation, JSP, ASP, ASP.NET, PHP that the data source uses to generate the data source's HTML web pages.

In accordance with one or more embodiments, where the BrowserScriptPost code snippet is provided as a JavaScript code snippet, the JavaScript function of component 902 reads the JavaScript object of component 901, and constructs (using any one of a number of methods that are well known to those of ordinary skill in the art) and adds a request for an image file from computer system 1000 to the data source's HTML web page. FIG. 16 shows pseudo code describing the JavaScript function of component 902. The request for the image file resource is constructed as an HTTP GET request with the key and value pairs of the JavaScript object of component 901 added in as parameters to the HTTP GET request. In addition to these GET parameters, a data transfer id identifying the data transfer configuration is also passed as a parameter to the JavaScript function of component 902. This data transfer id is also added as a parameter to the HTTP GET request. The data collected by the data source is thus passed on to computer system 1000 for onward transfer by computer system 1000 to the data consumer specified in the data transfer configuration.

In accordance with one or more embodiments, the data source can download the JavaScript for components 901 and 902 for each data source configuration set up using data source configurator 200 by clicking on the “Download Browser Script Enabler Code” button as shown on the screen shown in FIG. 5.

In accordance with one or more embodiments, where the BrowserScriptPost code snippet is provided as a JavaScript code snippet, component 903 is a call to the JavaScript function defined by component 902, which function accepts, as parameters, the data transfer id and the JavaScript object created by component 901, for example, send(123345, data). In accordance with one or more such embodiments, computer system 1000 will provide an instance of the JavaScript code to the data source for component 903 for each data transfer defined in data transfer configurator 300 that has been configured to accept data from the data source. The data source can download an instance of component 903 for each data transfer configuration by clicking on a “Download Browser Script Transfer Code” button on a screen provided. The unique data transfer id identifying the data transfer is generated by computer system 1000 on creation of a new data transfer configuration, and will be populated by computer system 1000 in each instance of the Java Script code snippet for component 903. For each instance where the data source wants to send collected data in component 901 to computer system 1000, the data source will place calls to the JavaScript function on the web page after placing the JavaScript code for component 901 and 902 using any technologies such as, for example and without limitation, JSP, ASP, ASP.NET, PHP that the data source uses to generate data source's HTML web pages.

Based on the examples given above for component 901 and 903, the HTTP GET request for an image resource from computer system 1000 will be constructed by component 902 as: https://pontiflex.comiscriptpost?transferid=123345 &name=name value&email=email value&zip=zip value.

The image resource request that will be added to the data source's HTML web page will be added as an HTML image tag that will look like <img src=“https://pontiflex.comiscriptpost?transferid=123345 &name=name value&email=email value&zip=zip value”/>.

In accordance with one or more embodiments, archiver 800 runs at a system-defined archival time interval, and moves data; older than the archival time interval, from primary data store 600 to an archival data warehouse of archiver 800 (in accordance with any one of a number of methods that are well known to those of ordinary skill in the art). A

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “providing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. A method comprising:
providing one or more advertisements associated with a first advertising campaign within one or more advertising placements, each of the one or more advertisements being configured to receive sign-up information from one or more users, the one or more advertising placements corresponding to one or more related advertising impressions;
receiving sign-up information from one or more users via the one or more advertisements;
sending, based on the sign-up information, one or more messages to each of the one or more users;
receiving one or more responses to the one or more messages;
determining, based on the one or more responses, a user engagement level of the first advertising campaign; and
forecasting, with a processing device and based on the user engagement level of the first advertising campaign, a user engagement level of a second advertising campaign.

2. The method of claim 1, wherein the one or more responses comprise at least one of: an opening of the message or an interaction with the message.

3. The method of claim 1, wherein determining a user engagement level further comprises determining, based on at least one of (a) prior user activity or (b) information pertaining to user interests, a user engagement level of the first advertising campaign.

4. The method of claim 1, wherein determining a user engagement level comprises adjusting a user engagement level of the first advertising campaign based on one or more instances of filtering of the one or more messages.

5. The method of claim 1, further comprising:
determining a take rate of the first advertising campaign; and
forecasting a take rate of the second advertising campaign based on the take rate of the first advertising campaign.

6. The method of claim 5, wherein forecasting a take rate of the second advertising campaign comprises adjusting the take rate of the second advertising campaign based on at least one of (a) a brand quality score of the second advertising campaign or (b) an offer incentive score of the second advertising campaign.

7. The method of claim 5, further comprising: optimizing one or more parameters of the second advertising campaign based on the user engagement level of the second advertising campaign and the take rate of the second advertising campaign.

8. The method of claim 1, further comprising adjusting a pricing associated with the second advertising campaign based on one or more parameters associated with the second advertising campaign and a minimum spending requirement.

9. The method of claim 1, wherein each of the one or more advertisements is associated with an advertiser.

10. A system comprising:
a memory; and
a processing device, coupled to the memory, to:
provide one or more advertisements associated with a first advertising campaign within one or more advertising placements, each of the one or more advertisements being configured to receive sign-up information from one or more users, the one or more advertising placements corresponding to one or more related advertising impressions;
receive sign-up information from one or more users via the one or more advertisements;
send, based on the sign-up information, one or more messages to each of the one or more users;
receive one or more responses to the one or more messages;
determine, based on the one or more responses, a user engagement level of the first advertising campaign; and
forecast, based on the user engagement level of the first advertising campaign, a user engagement level of a second advertising campaign.

11. The system of claim 10, wherein the one or more responses comprise at least one of:
an opening of the message or an interaction with the message.

12. The system of claim 10, wherein to determine a user engagement level is further to determine, based on at least one of (a) prior user activity or (b) information pertaining to user interests, a user engagement level of the first advertising campaign.

13. The system of claim 10, wherein to determine a user engagement level is to adjust a user engagement level of the first advertising campaign based on one or more instances of filtering of the one or more messages.

14. The system of claim 10, wherein the processing device is further to:
determine a take rate of the first advertising campaign; and
forecast a take rate of the second advertising campaign based on the take rate of the first advertising campaign.

15. The system of claim 14, wherein to forecast a take rate of the second advertising campaign is to adjust the take rate of the second advertising campaign based on at least one of (a) a brand quality score of the second advertising campaign or (b) an offer incentive score of the second advertising campaign.

16. The system of claim 14, wherein the processing device is further to optimize one or more parameters of the second advertising campaign based on the user engagement level of the second advertising campaign and the take rate of the second advertising campaign.

17. The system of claim 10, wherein the processing device is further to adjust a pricing associated with the second advertising campaign based on one or more parameters associated with the second advertising campaign and a minimum spending requirement.

18. The system of claim 10, wherein each of the one or more advertisements is associated with an advertiser.

19. A computer readable medium having instructions stored thereon that, when executed by a processor, cause the processor to perform operations comprising:
providing one or more advertisements associated with a first advertising campaign within one or more advertising placements, each of the one or more advertisements being configured to receive sign-up information from one or more users, the one or more advertising placements corresponding to one or more related advertising impressions;
receiving sign-up information from one or more users via the one or more advertisements;
sending, based on the sign-up information, one or more messages to each of the one or more users;
receiving one or more responses to the one or more messages;
determining, based on the one or more responses, a user engagement level of the first advertising campaign; and
forecasting, based on the user engagement level of the first advertising campaign, a user engagement level of a second advertising campaign.

20. The computer readable medium of claim 19, further comprising:
determining a take rate of the first advertising campaign; and
forecasting a take rate of the second advertising campaign based on the take rate of the first advertising campaign.
